(19) United States
(12) Patent Application Publication
(10) Pub. No.: US 2025/0093576 A1
(43) Pub. Date: Mar. 20, 2025

(54) PHOTONIC ELEMENT AND NETWORK OF PHOTONIC ELEMENTS

(71) Applicant: VIAVI Solutions Inc., Chandler, AZ (US)

(72) Inventor: William D. HOUCK, Santa Rosa, CA (US)

(21) Appl. No.: 18/634,469

(22) Filed: Apr. 12, 2024

Related U.S. Application Data
(60) Provisional application No. 63/583,454, filed on Sep. 18, 2023.

(51) Int. Cl. G02B 6/12

(52) U.S. Cl. CPC G02B 6/12002

(57) ABSTRACT

A photonic element includes a substrate; a plurality of layers disposed in a stack configuration in a first direction on the substrate; and a first optical transmission component, a second optical transmission component, a third optical transmission component, and a fourth optical transmission component. The first optical transmission component includes one or more optical transmission structures that are disposed in a first layer, the second optical transmission component includes one or more optical transmission structures that are disposed in a second layer, the third optical transmission component includes one or more optical transmission structures that disposed in a third layer, and the fourth optical transmission component includes one or more optical transmission structures that are disposed in a fourth layer. The second layer and the third layer are each disposed between the first layer and the fourth layer in the stack configuration.

### RELATED APPLICATION

This application claims priority to U.S. Provisional Patent Application No. 63/583,454, entitled “PHOTONIC ELEMENT AND NETWORK OF PHOTONIC ELEMENTS,” filed on Sep. 18, 2023, the content of which is incorporated by reference herein in its entirety.

### BACKGROUND

Integrated photonics is a branch of photonics in which waveguides and other photonic devices are fabricated as an integrated structure on a substrate surface. For example, a photonic integrated circuit (PIC) may use semiconductor-grade materials (e.g., silicon, indium phosphide, dielectrics such as silicon dioxide or silicon nitride, and/or the like) as a platform to integrate active and passive photonic circuits with electronic components on a single chip. As a result of integration, complex photonic circuits can process and transmit light (e.g., photons) in similar ways to how electronic integrated circuits process and transmit electrons.

### SUMMARY

In some implementations, a photonic element includes a substrate; a plurality of layers disposed in a stack configuration in a first direction on the substrate; and a first optical transmission component, a second optical transmission component, a third optical transmission component, and a fourth optical transmission component, wherein: the first optical transmission component includes one or more optical transmission structures that are disposed in a first layer of the plurality of layers, the second optical transmission component includes one optical transmission structure that is disposed in a second layer of the plurality of layers, the third optical transmission component includes one optical transmission structure that is disposed in a third layer of the plurality of layers, the fourth optical transmission component includes one or more optical transmission structures that are disposed in a fourth layer of the plurality of layers, and the second layer and the third layer are each disposed between the first layer and the fourth layer in the stack configuration.

In some implementations, a photonic element includes a substrate; a plurality of layers disposed in a stack configuration in a first direction on the substrate; and a first optical transmission component, a second optical transmission component, a third optical transmission component, and a fourth optical transmission component, wherein: the first optical transmission component includes two optical transmission structures that are disposed in a first layer of the plurality of layers, the second optical transmission component includes two optical transmission structures that are disposed in a second layer of the plurality of layers, the third optical transmission component includes one optical transmission structure that is disposed in a third layer of the plurality of layers, the fourth optical transmission component includes two optical transmission structures that are disposed in a fourth layer of the plurality of layers, and the second layer and the third layer are each disposed between the first layer and the fourth layer in the stack configuration, and the two optical transmission structures of the second optical transmission component and the one optical transmission structure of the third optical transmission component are arranged in an offset triter configuration.

In some implementations, a network of photonic elements includes a substrate; and a plurality of photonic elements disposed on respective regions of the substrate, wherein each photonic element, of the plurality of photonic elements, includes a first optical transmission component, a second optical transmission component, a third optical transmission component, and a fourth optical transmission component in a stack configuration, wherein: the first optical transmission component includes one or more optical transmission structures, the second optical transmission component includes one or two optical transmission structures, the third optical transmission component includes one optical transmission structure, the fourth optical transmission component includes one or more optical transmission structures, and the second optical transmission component and the third optical transmission component are each disposed between the first optical transmission component and the fourth optical transmission component in the stack configuration.

### BRIEF DESCRIPTION OF THE DRAWINGS

FIGS. 1A-1C show an example of a photonic element.

FIGS. 2A-2C show an example of a photonic element.

FIGS. 3A-3C show an example of a photonic element.

FIG. 4 shows an example of a network of a plurality of photonic elements.

FIGS. 5A-5C show an example of a photonic element.

FIGS. 6A-6C show an example of a photonic element.

FIGS. 7A-7C show an example of a photonic element.

FIG. 8 shows an example of a network of a plurality of photonic elements.

### DETAILED DESCRIPTION

The following detailed description of example implementations refers to the accompanying drawings. The same reference numbers in different drawings may identify the same or similar elements.

Traditional computer architectures are designed to be Turing complete, allowing them to be versatile and able to process a diverse array of computations. However, this versatility is typically achieved through the use of a von Neumann architecture, which is not well suited for processing artificial intelligence (AI) algorithms (e.g., because of the latency and power consumption requirements of such algorithms).

Integrated photonic hardware accelerators are specialized hardware devices that use photonic components for accelerating computational tasks, such as those relevant to AI processing. Such integrated photonic hardware accelerators use the unique properties of light, such as high-speed data transmission and parallelism, which can be used to perform AI processing tasks more efficiently. For example, integrated photonic hardware accelerators can be used for high throughput processing tasks (e.g., AI-specific processing tasks), such as matrix-vector multiplication (MVM) and general matrix multiplications (GEMM). Accordingly, advantages of integrated photonic hardware accelerators (e.g., as compared to traditional computer architecture) include greater processing speed, greater information capacity, and reduced energy consumption.

One of the basic building blocks in integrated photonic hardware accelerators (and more generally, in all programmable integrated photonic circuits) is a single analog optical gate, which consists of a 2×2 interference element (sometimes referred to as a unit cell). Individual unit cells can be cascaded into meshes of two-dimensional networks to provide computational complexity. However, due to the two-dimensional nature of such networks, a complexity that can be achieved with such a network is limited. For example, crossings between individual unit cells cannot be formed, and therefore the networks require an enormous amount of redundancy (sometimes referred to as matrix decomposition) to achieve a multi-layer network (e.g., comprising multiple computational layers).

Some implementations described herein include a photonic element. The photonic element may be a photonic circuit, a unit cell, a photonic integrated circuit (PIC) (e.g., that includes one or more interferometers), an optical logic gate, an optical switch, an optical amplifier, an optical modulator, and/or a frequency comb, among other examples.

The photonic element includes a substrate (e.g., a glass substrate, a silicon substrate, or a germanium substrate) and a plurality of layers that comprise at least a cladding material (e.g., an oxide material, such as a silicon dioxide material; a polymer material, such as a siloxane polymer material; or another cladding material) that are disposed on the substrate (e.g., in a stack). The photonic element further includes a plurality of optical transmission components. Each optical transmission component is disposed within a particular layer of the plurality of layers of the photonic element (e.g., within the cladding material of the particular layer).

Each optical transmission component is configured to transmit light. For example, each optical transmission component may be a waveguide, an interferometer, an optical switch, an optical resonator, and/or another optical transmission component. In some implementations, each optical transmission component comprises at least one of a non-alkali, oxide solution that includes a cation that is niobium, an alkali oxide material, an amorphous silicon (a-Si) material, a hydrogenated amorphous silicon (a-Si:H) material, a nitride-based material, an oxide-based material, or a semiconductor material, among other examples. Each optical transmission component includes one or more optical transmission structures. An optical transmission structure may is a distinct portion of the optical transmission component.

In this way, some implementations described herein include a photonic element with a three-dimensional architecture (e.g., multiple optical transmission components arranged in a stack configuration in respective layers on a substrate). Accordingly, by enabling a three-dimensional architecture through multilayer integration and leveraging a high refractive index (e.g., through sputtered metal oxides, or other materials), the photonic element is smaller (e.g., five to ten times smaller) than a comparable meshes (e.g., a two-dimensional mesh) that would be required to provide a similar functionality using an existing two-dimensional architectures. This reduction in size of computational functionality provides improved scale for networking photonic elements together (e.g., the photonic elements take advantage of real-estate in three dimensions and therefore avoids complexity and cost due to matrix decomposition that is required for two-dimensional layouts). The photonic element therefore enables AI computations, as well as other applications such as quantum computing, where loss and space limitations have caused significant bottlenecks in two-dimensional layouts.

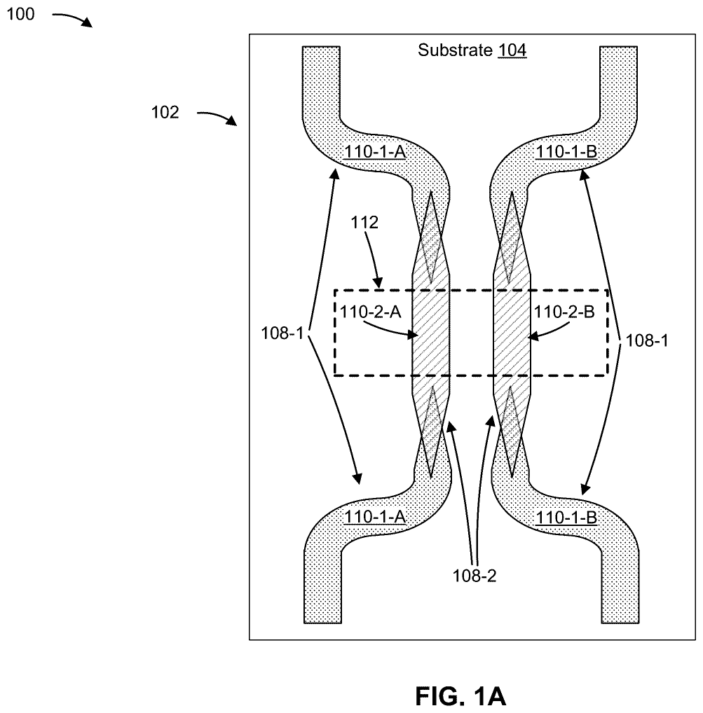

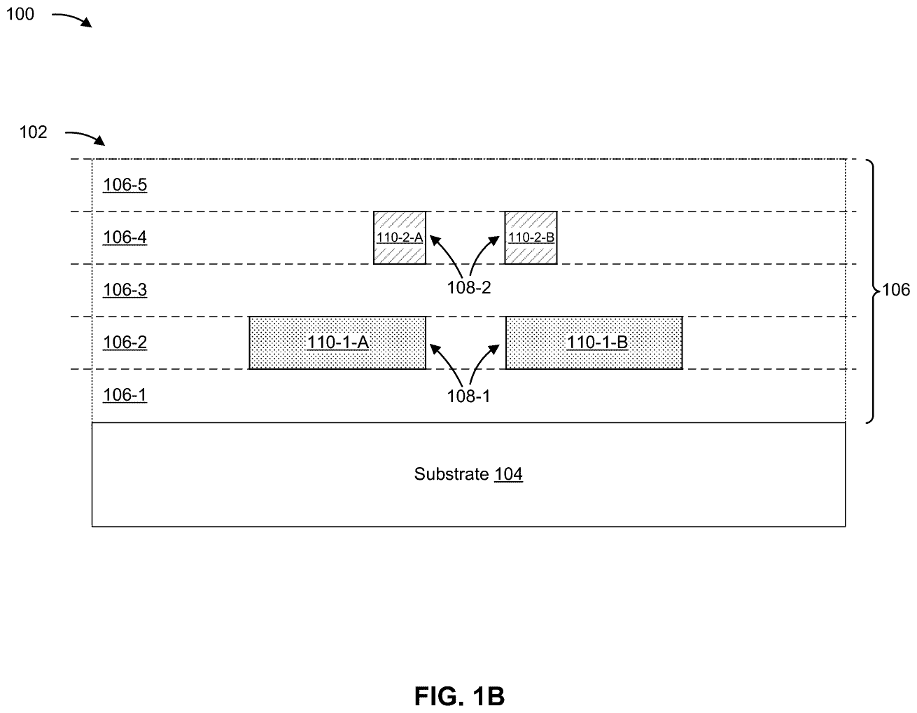

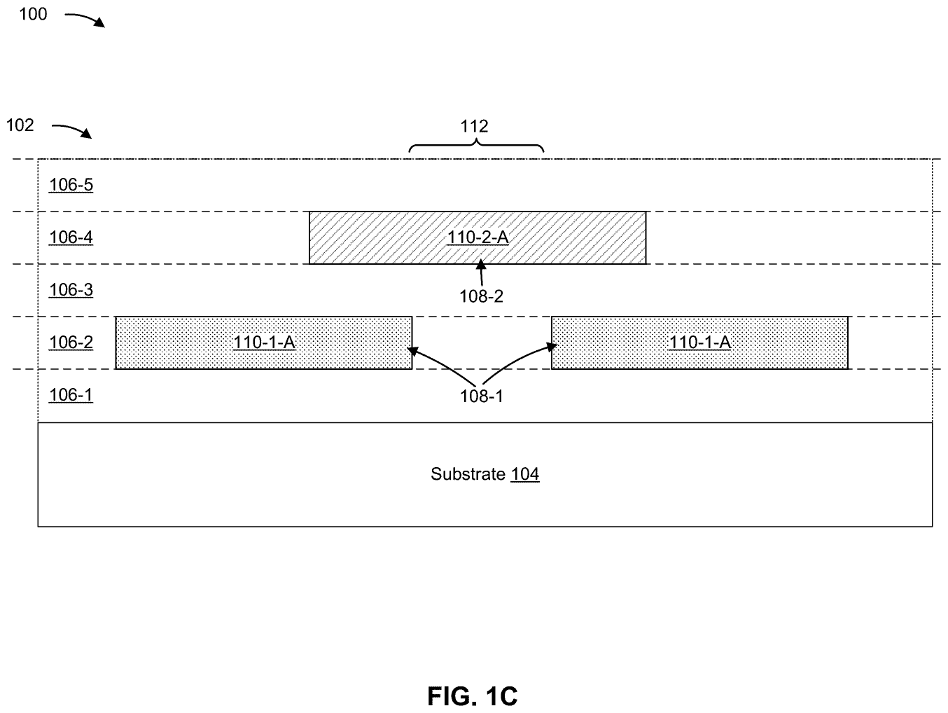

FIGS. 1A-1C show an example 100 of a photonic element 102. The photonic element 102 may be a photonic circuit, a unit cell, a PIC (e.g., that includes one or more interferometers), an optical logic gate, an optical switch, an optical amplifier, an optical modulator, and/or a frequency comb, among other examples. FIG. 1A shows a top-down view of the photonic element 102, FIG. 1B shows a first side view of the photonic element 102 (e.g., a “bottom side” view of the photonic element 102, as shown in FIG. 1A); and FIG. 1C shows a second side view of the photonic element 102 (e.g., a “left side” view of the photonic element 102, as shown in FIG. 1A).

As shown in FIGS. 1A-1C, the photonic element 102 may include a substrate 104, a plurality of layers 106 (shown as layers 106-1 through 106-5), and a plurality of optical transmission components 108 (shown as optical transmission components 108-1 and 108-2). The substrate 104 may include a substrate upon which other layers, structures, and/or components shown in FIGS. 1A-1C are formed. The substrate 104 may be a transmissive substrate, such as a glass substrate, a silicon (Si) substrate, or a germanium (Ge) substrate.

The plurality of layers 106 may be disposed on the substrate 104, such as in a stack configuration (e.g., in a first direction) on the substrate 104. For example, as shown in FIGS. 1B-1C, the plurality of layers 106 (shown as layers 106-1 through 106-5) may be disposed in a stack configuration (e.g., in a vertical direction) on a top surface of the substrate 104. That is, a layer 106-1 may be disposed on the top surface of the substrate 104, a layer 106-2 may be disposed on a top surface of the layer 106-2, a layer 106-3 may be disposed on a top surface of the layer 106-2, and so on. Accordingly, a particular layer 106 that is disposed “over” a first other layer 106 and “below” a second other layer 106 in the stack configuration, may be referred to as disposed “between” the first other layer 106 and the second other layer 106 in the stack configuration. Each layer 106, of the plurality of layers 106, may comprise a cladding material that include includes at least one of an oxide material (e.g., a silicon dioxide (SiO₂) material), a polymer material (e.g., a siloxane polymer material), a fluoride material (e.g., a magnesium fluoride (MgF₂) material, a calcium fluoride (CaF₂) material, or a lithium fluoride (LiF) material), or another material. In some implementations, a layer 106, such as a “top” layer (e.g., layer 106-5 shown in FIGS. 1B-1C) may comprise an air cladding.

Each optical transmission component 108 of the plurality of optical transmission components 108 may be configured to transmit light. For example, each optical transmission component 108 may be a waveguide, an interferometer, an optical switch, an optical resonator, and/or another optical transmission component. In some implementations, each optical transmission component 108 may comprise at least a non-alkali, oxide solution that includes a cation that is niobium. The non-alkali, oxide solution that includes a cation that is niobium may include at least one of a non-alkali, binary oxide solution that includes a cation that is niobium; a non-alkali, ternary oxide solution that includes a cation that is niobium; a non-alkali, quaternary oxide solution that includes a cation that is niobium; or a non-alkali, quinary oxide solution that includes a cation that is niobium (and so on). For example, each optical transmission component 108 may include at least one of a niobium tantalum oxide solution, a niobium titanium oxide solution, or a niobium tantalum titanium oxide solution. As another example, each optical transmission component 108 may include at least one of a niobium aluminum oxide solution, a niobium strontium oxide solution, a niobium aluminum strontium oxide solution, a niobium tantalum aluminum oxide solution, a niobium titanium aluminum oxide solution, a niobium tantalum strontium solution, a niobium titanium strontium oxide solution, a niobium titanium tantalum aluminum oxide solution, a niobium titanium tantalum strontium oxide solution, a niobium titanium aluminum strontium oxide solution, a niobium tantalum aluminum strontium oxide solution, or a niobium titanium tantalum aluminum strontium oxide solution. In some implementations, each optical transmission component 108 may comprise at least one of a non-alkali, oxide solution that includes a cation that is niobium, an alkali oxide material (e.g., that includes at least lithium niobate, barium titanate, and/or another alkali oxide material), an amorphous silicon (a-Si) material, a hydrogenated amorphous silicon (a-Si:H) material, a nitride-based material, an oxide-based material, or a semiconductor material, among other examples.

Each optical transmission component 108 may include one or more optical transmission structures 110. An optical transmission structure 110 may be a distinct portion of the optical transmission component 108. For example, as shown in FIG. 1A, an optical transmission component 108-1 (shown with gray shading) may include two optical transmission structures 110-1: a first optical transmission structure 110-1-A (shown as a “left” optical transmission structure) and a second optical transmission structure 110-1-B (shown as a “right” optical transmission structure). An optical transmission structure 110 may have one or more discrete elements. For example, as shown in FIG. 1A, the first optical transmission structure 110-1-A may include a “top” element and a “bottom” element that are separated by a gap, and the second optical transmission structure 110-1-B may include a “top” element and a “bottom” element that are separated by a gap. As further shown in FIG. 1A, an optical transmission component 108-2 (shown with left-to-right diagonal patterning) may include two optical transmission structures 110-2: a first optical transmission structure 110-2-A (shown as a left optical transmission structure) and a second optical transmission structure 110-2-B (shown as a right optical transmission structure), where each comprises one discrete element.

As shown in FIGS. 1A and 1C, the photonic element 102 may include a region 112 (e.g., a central region of the photonic element 102 in a second direction that is orthogonal to the first direction, such as in a horizontal direction). At least a portion of the optical transmission component 108-2 may be associated with the region 112. For example, at least a portion of the two optical transmission structures 110-2-A and 110-2-B may be present within the region 112. Additionally, or alternatively, no portion of the optical transmission component 108-1 may be associated with the region 112. For example, no portion of the two optical transmission structures 110-1-A and 110-1-B may be present within the region 112. This may be because of the respective gaps that separate the elements of the first optical transmission structure 110-1-A and the elements of the second optical transmission structure 110-1-B.

Each optical transmission component 108 may be disposed in a particular layer of the plurality of layers 106. For example, as shown in FIGS. 1B and 1C, the optical transmission component 108-1 may be disposed in the layer 106-2 (e.g., the two optical transmission structures 110-1-A and 110-1-B may be disposed in the layer 106-2) and the optical transmission component 108-2 may be disposed in the layer 106-4 (e.g., the two optical transmission structures 110-2-A and 110-2-B may be disposed in the layer 106-4). Accordingly, as shown in FIGS. 1B-1C, a layer 106, of the plurality of layers 106, may include a particular optical transmission component 108, or may not include any optical transmission component 108.

As indicated above, FIGS. 1A-1C are provided as an example. Other examples may differ from what is described with regard to FIGS. 1A-1C. In practice, the photonic element 102 may include additional layers, components, and/or structures; fewer layers, components, and/or structures; different layers, components, and/or structures; or differently arranged layers, components, and/or structures than those shown in FIGS. 1A-1C.

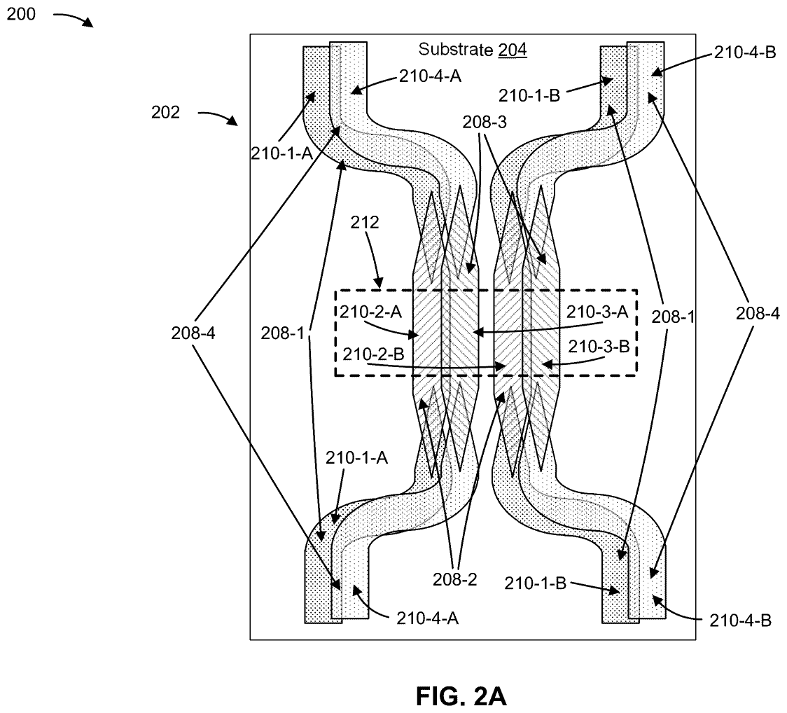

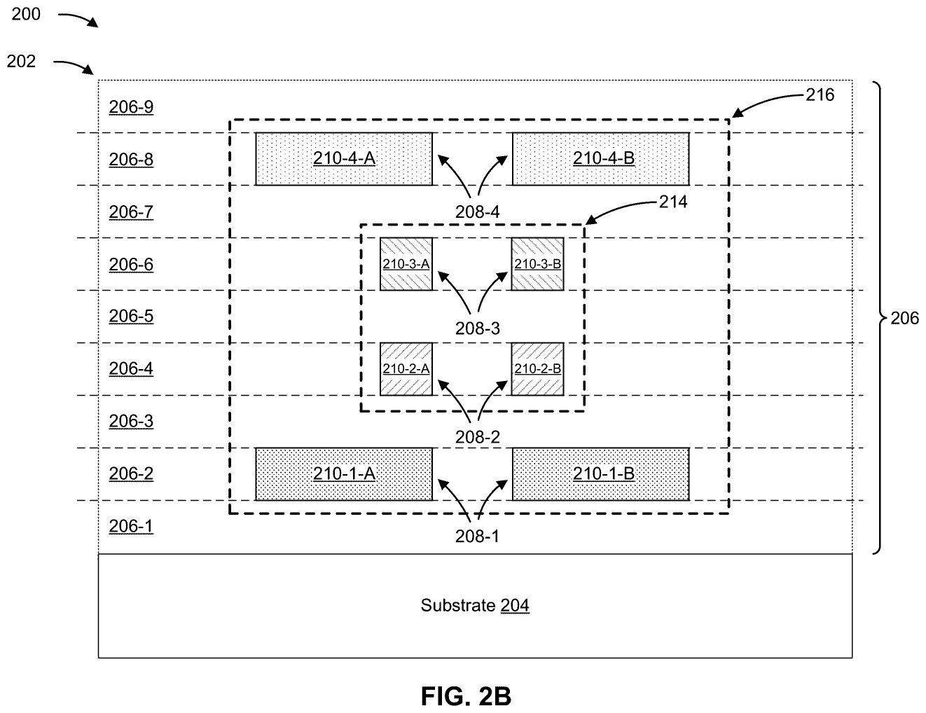

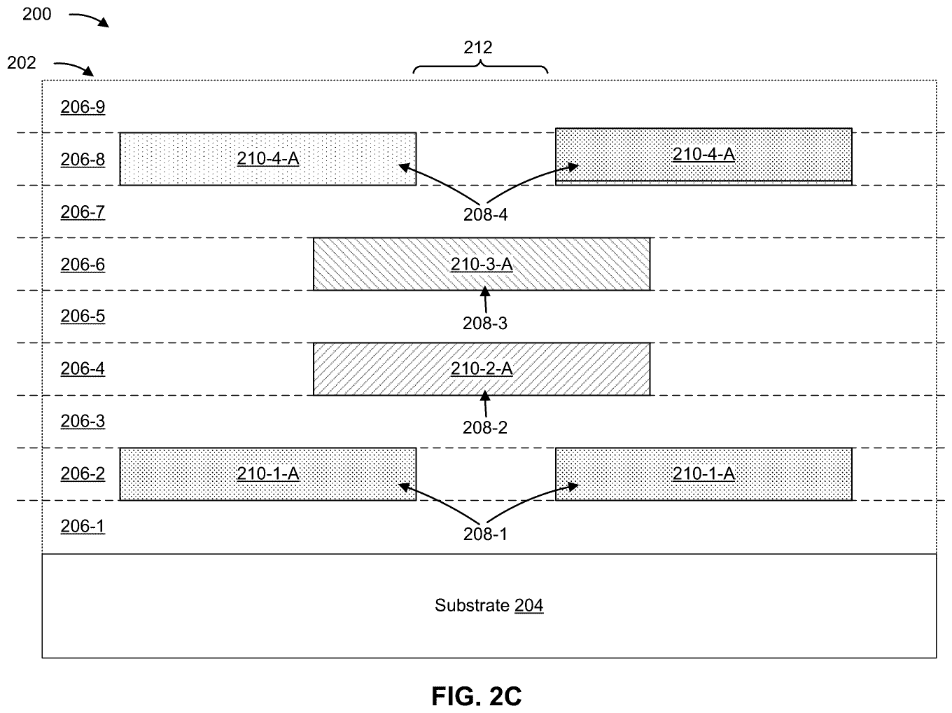

FIGS. 2A-2C show an example 200 of a photonic element 202. The photonic element 202 may be a photonic circuit, a unit cell, a PIC (e.g., that includes one or more interferometers), an optical logic gate, an optical switch, an optical amplifier, an optical modulator, and/or a frequency comb, among other examples. FIG. 2A shows a top-down view of the photonic element 202, FIG. 2B shows a first side view of the photonic element 202 (e.g., a view from a bottom side of the photonic element 202, as shown in FIG. 2A); and FIG. 2C shows a second side view of the photonic element 202 (e.g., a view from a left side of the photonic element 202, as shown in FIG. 2A).

As shown in FIGS. 2A-2C, the photonic element 202 may include a substrate 204, a plurality of layers 206 (shown as layers 206-1 through 206-9), and a plurality of optical transmission components 208 (shown as optical transmission components 208-1 through 208-4). The substrate 204, the plurality of layers 206, and the plurality of optical transmission components 208 may be the same as, or similar to, corresponding components described elsewhere herein.

The plurality of layers 206 may be disposed on the substrate 204, such as in a stack configuration (e.g., in a first direction) on the substrate 204. For example, as shown in FIGS. 2B-2C, the plurality of layers 206 (shown as layers 206-1 through 206-9) may be disposed in a stack configuration (e.g., in a vertical direction) on a top surface of the substrate 204. Accordingly, a particular layer 206 that is disposed over a first other layer 206 and below a second other layer 206 in the stack configuration, may be referred to as disposed between the first other layer 206 and the second other layer 206 in the stack configuration. Each layer 206, of the plurality of layers 206, may comprise a cladding material that include includes at least one of an oxide material (e.g., a silicon dioxide (SiO₂) material), a fluoride material (e.g., a magnesium fluoride (MgF₂) material, a calcium fluoride (CaF₂) material, or a lithium fluoride (LiF) material), a polymer material (e.g., a siloxane polymer material), or another material. In some implementations, a layer 206, such as a top layer (e.g., layer 206-9 shown in FIGS. 2B-2C) may comprise an air cladding.

Each optical transmission component 208 of the plurality of optical transmission components 208 may be configured to transmit light. For example, each optical transmission component 208 may be a waveguide, an interferometer, an optical switch, an optical resonator, and/or another optical transmission component. In some implementations, each optical transmission component 208 may comprise at least one of a non-alkali, oxide solution that includes a cation that is niobium, an alkali oxide material, an amorphous silicon (a-Si) material, a hydrogenated amorphous silicon (a-Si:H) material, a nitride-based material, an oxide-based material, or a semiconductor material, among other examples.

Each optical transmission component 208 may include one or more optical transmission structures 210. An optical transmission structure 210 may be a distinct portion of the optical transmission component 208. For example, as shown in FIG. 2A, an optical transmission component 208-1 (shown with dark gray shading) may include two optical transmission structures 210-1: a first optical transmission structure 210-1-A (shown as a left optical transmission structure) and a second optical transmission structure 210-1-B (shown as a right optical transmission structure). An optical transmission structure 210 may have one or more discrete elements. For example, as shown in FIG. 2A, the first optical transmission structure 210-1-A may include a top element and a bottom element that are separated by a gap, and the second optical transmission structure 210-1-B may include a top element and a bottom element that are separated by a gap.

As further shown in FIG. 2A, an optical transmission component 208-2 (shown with left-to-right diagonal patterning) may include two optical transmission structures 210-2: a first optical transmission structure 210-2-A (shown as a left optical transmission structure) and a second optical transmission structure 210-2-B (shown as a right optical transmission structure), where each optical transmission structure 210-2 comprises one discrete element; an optical transmission component 208-3 (shown with right-to-left diagonal patterning) may include two optical transmission structures 210-3: a first optical transmission structure 210-3-A (shown as a left optical transmission structure) and a second optical transmission structure 210-3-B (shown as a right optical transmission structure), where each optical transmission structure 210-3 comprises one discrete element; and an optical transmission component 208-4 (shown with light gray shading) may include two optical transmission structures 210-4: a first optical transmission structure 210-4-A (shown as a left optical transmission structure) and a second optical transmission structure 210-4-B (shown as a right optical transmission structure), where each optical transmission structure 210-4 comprises multiple discrete elements.

As shown in FIGS. 2A and 2C, the photonic element 202 may include a region 212 (e.g., a central region of the photonic element 202 in a second direction that is orthogonal to the first direction, such as in a horizontal direction). At least a portion of the optical transmission component 208-2 and/or at least a portion of the optical transmission component 208-3 may be associated with the region 212. For example, at least a portion of the two optical transmission structures 210-2-A and 210-2-B of the optical transmission component 208-2 and/or at least a portion of the two optical transmission structures 210-3-A and 210-3-B of the optical transmission component 208-3 may be present within the region 212. Additionally, or alternatively, no portion of the optical transmission component 208-1 and/or no portion of the optical transmission component 208-4 may be associated with the region 212. For example, no portion of the two optical transmission structures 210-1-A and 210-1-B of the optical transmission component 208-1 and/or the two optical transmission structures 210-4-A and 210-4-B of the optical transmission component 208-4 may be present within the region 212. This may be because of the respective gaps that separate the discrete elements of the first optical transmission structure 210-1-A and the discrete elements of the second optical transmission structure 210-1-B and/or the respective gaps that separate the discrete elements of the first optical transmission structure 210-4-A and the discrete elements of the second optical transmission structure 210-4-B.

Each optical transmission component 208 may be disposed in a particular layer of the plurality of layers 206. For example, as shown in FIGS. 2B and 2C, the optical transmission component 208-1 may be disposed in the layer 206-2 (e.g., the two optical transmission structures 210-1-A and 210-1-B may be disposed in the layer 206-2), the optical transmission component 208-2 may be disposed in the layer 206-4 (e.g., the two optical transmission structures 210-2-A and 210-2-B may be disposed in the layer 206-4), the optical transmission component 208-3 may be disposed in the layer 206-6 (e.g., the two optical transmission structures 210-3-A and 210-3-B may be disposed in the layer 206-6), and the optical transmission component 208-4 may be disposed in the layer 206-8 (e.g., the two optical transmission structures 210-4-A and 210-4-B may be disposed in the layer 206-8). Accordingly, as shown in FIGS. 2B-2C, a layer 206, of the plurality of layers 206, may include a particular optical transmission component 208, or may not include any optical transmission component 208.

As shown in FIG. 2B, the two optical transmission structures 210-2-A and 210-2-B of the optical transmission component 208-2 and the two optical transmission structures 210-3-A and 210-3-B of the optical transmission component 208-3 may be arranged in a “quarter” configuration. For example, the two optical transmission structures 210-2-A and 210-2-B may be disposed in a first same layer (e.g., the layer 206-4) and the and the two optical transmission structures 210-3-A and 210-3-B may be disposed in a second same layer (e.g., the layer 206-6), and the optical transmission structure 210-2-A and the optical transmission structure 210-3-A may be aligned in the first direction (e.g., the vertical direction shown in FIG. 2B) and the optical transmission structure 210-2-B and the optical transmission structure 210-3-B may also be aligned in the first direction. Two optical transmission structures 210 are aligned in the first direction when a line that is parallel (e.g., within a tolerance, such as 1 degree, 2 degrees, or 3 degrees) to the first direction passes through both of the two optical transmission structures 210.

In some implementations, the two optical transmission structures 210-2-A and 210-2-B of the optical transmission component 208-2 and the two optical transmission structures 210-3-A and 210-3-B of the optical transmission component 208-3 may be configured to be evanescently coupled with each other. For example, the two optical transmission structures 210-2-A and 210-2-B of the optical transmission component 208-2 and the two optical transmission structures 210-3-A and 210-3-B of the optical transmission component 208-3 may be spaced within a threshold distance of each other to enable evanescent coupling. Additionally, or alternatively, the two optical transmission structures 210-2-A and 210-2-B of the optical transmission component 208-2 and the two optical transmission structures 210-1-A and 210-1-B of the optical transmission component 208-1 may be configured to be evanescently coupled with each other and/or the two optical transmission structures 210-3-A and 210-3-B of the optical transmission component 208-3 and the two optical transmission structures 210-4-A and 210-4-B of the optical transmission component 208-4 may be configured to be evanescently coupled with each other.

As further shown in FIG. 2B, the photonic element 202 may include a region 214 (e.g., a quadrilateral region of the photonic element 202 in the first direction). The two optical transmission structures 210-2-A and 210-2-B of the optical transmission component 208-2 and the two optical transmission structures 210-3-A and 210-3-B of the optical transmission component 208-3 may be associated with the region 214. For example, the region 214 may include the two optical transmission structures 210-2-A and 210-2-B of the optical transmission component 208-2 and the two optical transmission structures 210-3-A and 210-3-B of the optical transmission component 208-3, where “corners” of the region 214 are respectively defined to include (e.g., surround) the two optical transmission structures 210-2-A and 210-2-B of the optical transmission component 208-2 and the two optical transmission structures 210-3-A and 210-3-B of the optical transmission component 208-3. Accordingly, the region 214 may include at least portions of the layers 206 that include the two optical transmission structures 210-2-A and 210-2-B of the optical transmission component 208-2 and the two optical transmission structures 210-3-A and 210-3-B of the optical transmission component 208-3 (e.g., the layers 206-4 and 206-6) and any layer in between (e.g., the layer 206-5).

As further shown in FIG. 2B, the photonic element 202 may include a region 216 (e.g., a quadrilateral region of the photonic element 202 in the first direction). The two optical transmission structures 210-1-A and 210-1-B of the optical transmission component 208-1 and the two optical transmission structures 210-4-A and 210-4-B of the optical transmission component 208-4 may be associated with the region 216. For example, the region 216 may include the two optical transmission structures 210-1-A and 210-1-B of the optical transmission component 208-1 and the two optical transmission structures 210-4-A and 210-4-B of the optical transmission component 208-4, such as where corners of the region 216 are respectively defined to include (e.g., surround) the two optical transmission structures 210-1-A and 210-1-B of the optical transmission component 208-1 and the two optical transmission structures 210-4-A and 210-4-B of the optical transmission component 208-4. Accordingly, the region 216 may include at least portions of the layers 206 that include the two optical transmission structures 210-1-A and 210-1-B of the optical transmission component 208-1 and the two optical transmission structures 210-4-A and 210-4-B (e.g., the layers 206-2 and 206-8) and any layer in between (e.g., the layer 206-3 through 206-7). As further shown in FIG. 2B, the region 216 may surround the region 214.

As indicated above, FIGS. 2A-2C are provided as an example. Other examples may differ from what is described with regard to FIGS. 2A-2C. In practice, the photonic element 202 may include additional layers, components, and/or structures; fewer layers, components, and/or structures; different layers, components, and/or structures; or differently arranged layers, components, and/or structures than those shown in FIGS. 2A-2C.

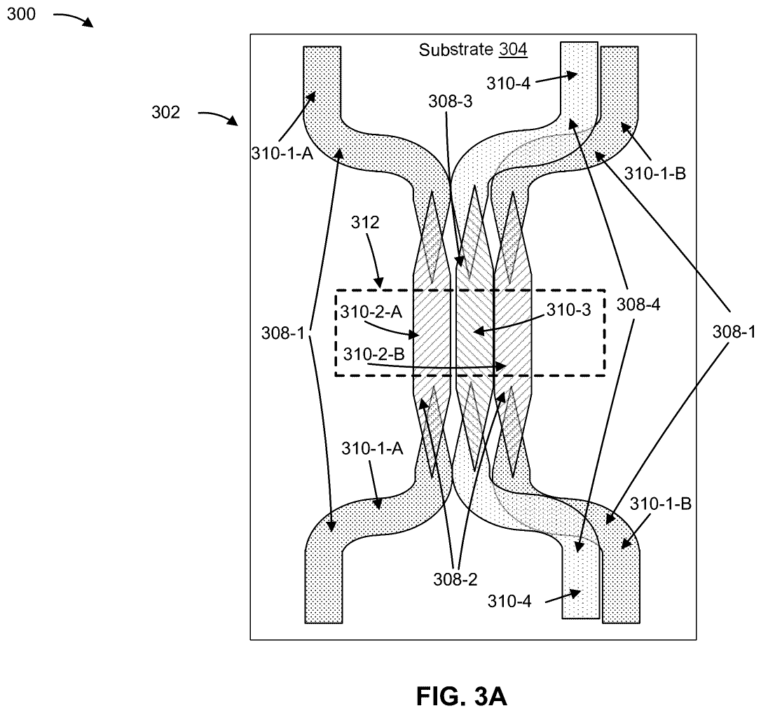

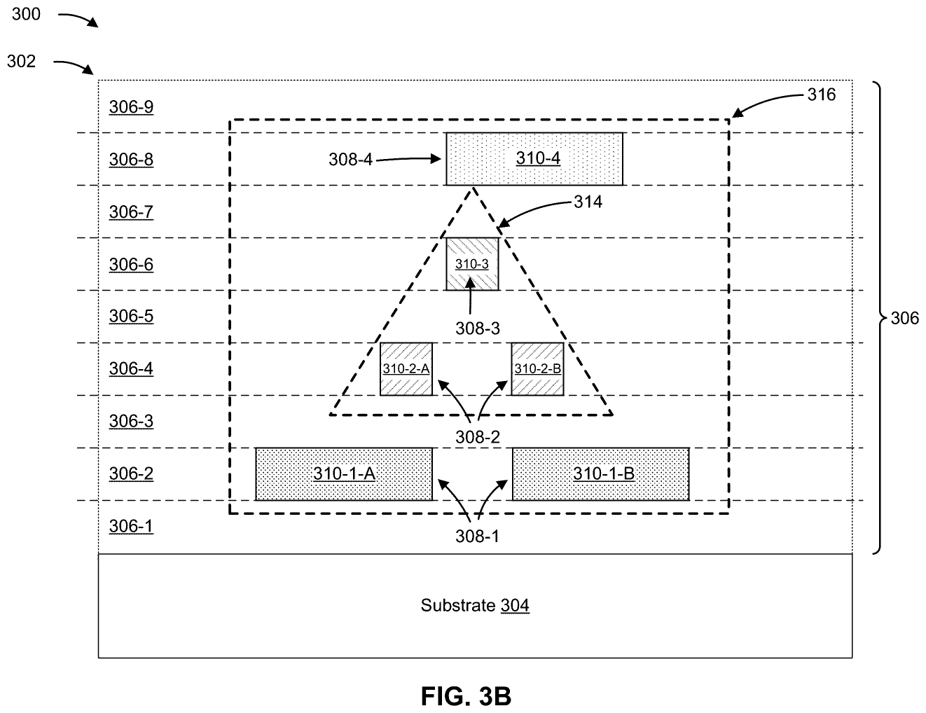

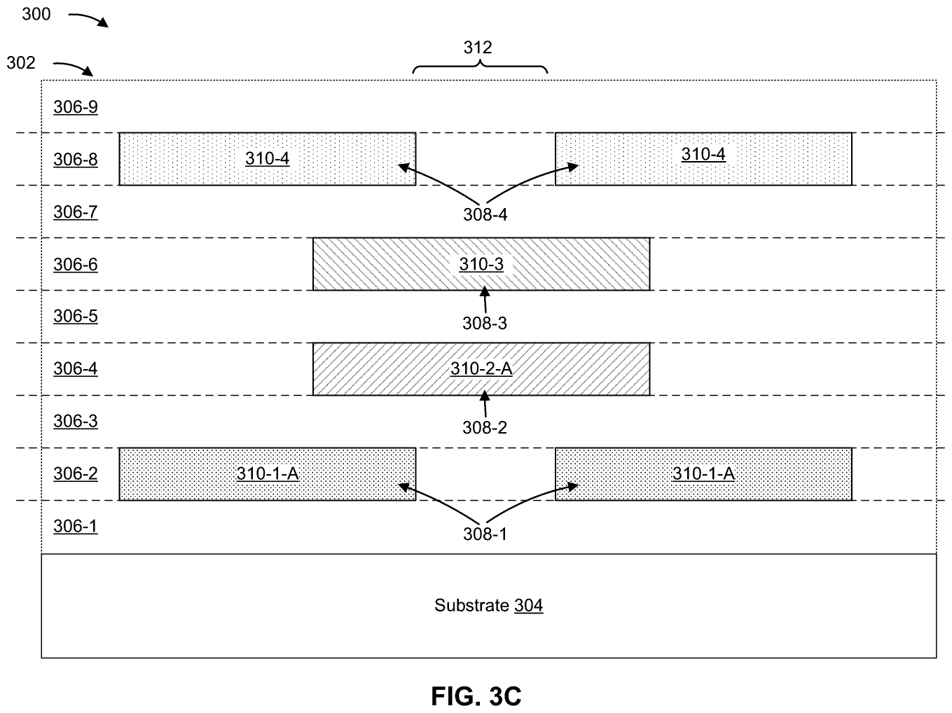

FIGS. 3A-3C show an example 300 of a photonic element 302. The photonic element 302 may be a photonic circuit, a unit cell, a PIC (e.g., that includes one or more interferometers), an optical logic gate, an optical switch, an optical amplifier, an optical modulator, and/or a frequency comb, among other examples. FIG. 3A shows a top-down view of the photonic element 302, FIG. 3B shows a first side view of the photonic element 302 (e.g., a view from a bottom side of the photonic element 302, as shown in FIG. 3A); and FIG. 3C shows a second side view of the photonic element 302 (e.g., a view from a left side of the photonic element 302, as shown in FIG. 3A).

As shown in FIGS. 3A-3C, the photonic element 302 may include a substrate 304, a plurality of layers 306 (shown as layers 306-1 through 306-9), and a plurality of optical transmission components 308 (shown as optical transmission components 308-1 through 308-3). The substrate 304, the plurality of layers 306, and the plurality of optical transmission components 308 may be the same as, or similar to, corresponding components described elsewhere herein.

The plurality of layers 306 may be disposed on the substrate 304, such as in a stack configuration (e.g., in a first direction) on the substrate 304. For example, as shown in FIGS. 3B-3C, the plurality of layers 306 (shown as layers 306-1 through 306-9) may be disposed in a stack configuration (e.g., in a vertical direction) on a top surface of the substrate 304. Accordingly, a particular layer 306 that is disposed over a first other layer 306 and below a second other layer 306 in the stack configuration, may be referred to as disposed between the first other layer 306 and the second other layer 306 in the stack configuration. Each layer 306, of the plurality of layers 306, may comprise a cladding material that include includes at least one of an oxide material (e.g., a silicon dioxide (SiO₂) material), a polymer material (e.g., a siloxane polymer material), a fluoride material (e.g., a magnesium fluoride (MgF₂) material, a calcium fluoride (CaF₂) material, or a lithium fluoride (LiF) material), or another material. In some implementations, a layer 306, such as a top layer (e.g., layer 306-9 shown in FIGS. 3B-3C) may comprise an air cladding.

Each optical transmission component 308 of the plurality of optical transmission components 308 may be configured to transmit light. For example, each optical transmission component 308 may be a waveguide, an interferometer, an optical switch, an optical resonator, and/or another optical transmission component. In some implementations, each optical transmission component 308 may comprise at least one of a non-alkali, oxide solution that includes a cation that is niobium, an alkali oxide material, an amorphous silicon (a-Si) material, a hydrogenated amorphous silicon (a-Si:H) material, a nitride-based material, an oxide-based material, or a semiconductor material, among other examples.

Each optical transmission component 308 may include one or more optical transmission structures 310. An optical transmission structure 310 may be a distinct portion of the optical transmission component 308. For example, as shown in FIG. 3A, an optical transmission component 308-1 (shown with dark gray shading) may include two optical transmission structures 310-1: a first optical transmission structure 310-1-A (shown as a left optical transmission structure) and a second optical transmission structure 310-1-B (shown as a right optical transmission structure). An optical transmission structure 310 may have one or more discrete elements. For example, as shown in FIG. 3A, the first optical transmission structure 310-1-A may include a top element and a bottom element that are separated by a gap, and the second optical transmission structure 310-1-B may include a top element and a bottom element that are separated by a gap.

As further shown in FIG. 3A, an optical transmission component 308-2 (shown with left-to-right diagonal patterning) may include two optical transmission structures 310-2: a first optical transmission structure 310-2-A (shown as a left optical transmission structure) and a second optical transmission structure 310-2-B (shown as a right optical transmission structure), where each optical transmission structures 310-2 comprises one discrete element; an optical transmission component 308-3 (shown with right-to-left diagonal patterning) may include one optical transmission structures 310-3 that comprises one discrete element; and an optical transmission component 308-4 (shown with light gray shading) may include one optical transmission structures 310-4 that comprises multiple discrete elements.

As shown in FIGS. 3A and 3C, the photonic element 302 may include a region 312 (e.g., a central region of the photonic element 302 in a second direction that is orthogonal to the first direction, such as in a horizontal direction). At least a portion of the optical transmission component 308-2 and/or at least a portion of the optical transmission component 308-3 may be associated with the region 312. For example, at least a portion of the two optical transmission structures 310-2-A and 310-2-B of the optical transmission component 308-2 and/or at least a portion of the optical transmission structure 310 may be present within the region 312. Additionally, or alternatively, no portion of the optical transmission component 308-1 and/or no portion of the optical transmission component 308-4 may be associated with the region 312. For example, no portion of the two optical transmission structures 310-1-A and 310-1-B of the optical transmission component 308-1 and/or the one optical transmission structure 310-4 of the optical transmission component 308-4 may be present within the region 312. This may be because of the respective gaps that separate the discrete elements of the first optical transmission structure 310-1-A and the discrete elements of the second optical transmission structure 310-1-B and/or the gaps that separate the discrete elements of the first optical transmission structure 310-4.

Each optical transmission component 308 may be disposed in a particular layer of the plurality of layers 306. For example, as shown in FIGS. 3B and 3C, the optical transmission component 308-1 may be disposed in the layer 306-2 (e.g., the two optical transmission structures 310-1-A and 310-1-B may be disposed in the layer 306-2), the optical transmission component 308-2 may be disposed in the layer 306-4 (e.g., the two optical transmission structures 310-2-A and 310-2-B may be disposed in the layer 306-4), the optical transmission component 308-3 may be disposed in the layer 306-6 (e.g., the optical transmission structure 310-3 may be disposed in the layer 306-6), and the optical transmission component 308-4 may be disposed in the layer 306-8 (e.g., the optical transmission structure 310-4 may be disposed in the layer 306-8). Accordingly, as shown in FIGS. 3B-3C, a layer 306, of the plurality of layers 306, may include a particular optical transmission component 308, or may not include any optical transmission component 308.

As shown in FIG. 3B, the two optical transmission structures 310-2-A and 310-2-B of the optical transmission component 308-2 and the one optical transmission structure 310-3 of the optical transmission component 308-3 may be arranged in a “triter” configuration. For example, the two optical transmission structures 310-2-A and 310-2-B may be disposed in a first layer (e.g., the layer 306-4) and the and the one optical transmission structure 310-3 may be disposed in a second layer (e.g., the layer 306-6), and the optical transmission structure 310-3 may be aligned in the first direction (e.g., the vertical direction shown in FIG. 3B) with a midpoint between the two optical transmission structures 310-2-A and 310-2-B.

In some implementations, the two optical transmission structures 310-2-A and 310-2-B of the optical transmission component 308-2 and the one optical transmission structure 310-3 of the optical transmission component 308-3 may be configured to be evanescently coupled with each other. For example, the two optical transmission structures 310-2-A and 310-2-B of the optical transmission component 308-2 and the one optical transmission structure 310-3 of the optical transmission component 308-3 may be spaced within a threshold distance of each other to enable evanescent coupling. Additionally, or alternatively, the two optical transmission structures 310-2-A and 310-2-B of the optical transmission component 308-2 and the two optical transmission structures 310-1-A and 310-1-B of the optical transmission component 308-1 may be configured to be evanescently coupled with each other and/or the one optical transmission structure 310-3 of the optical transmission component 308-3 and the one optical transmission structures 310-4 of the optical transmission component 308-4 may be configured to be evanescently coupled with each other.

As further shown in FIG. 3B, the photonic element 302 may include a region 314 (e.g., a triangle region of the photonic element 302 in the first direction). The two optical transmission structures 310-2-A and 310-2-B of the optical transmission component 308-2 and the one optical transmission structure 310-3 of the optical transmission component 308-3 may be associated with the region 314. For example, the region 314 may include the two optical transmission structures 310-2-A and 310-2-B of the optical transmission component 308-2 and the one optical transmission structure 310-3 of the optical transmission component 308-3, where corners of the region 314 are respectively defined to include (e.g., surround) the two optical transmission structures 310-2-A and 310-2-B of the optical transmission component 308-2 and the one optical transmission structures 310-3 of the optical transmission component 308-3. Accordingly, the region 314 may include at least portions of the layers 306 that include the two optical transmission structures 310-2-A and 310-2-B of the optical transmission component 308-2 and the one optical transmission structure 310-3 of the optical transmission component 308-3 (e.g., the layers 306-4 and 306-6) and any layer in between (e.g., the layer 306-5).

As further shown in FIG. 3B, the photonic element 302 may include a region 316 (e.g., a quadrilateral region of the photonic element 302 in the first direction). The two optical transmission structures 310-1-A and 310-1-B of the optical transmission component 308-1 and the one optical transmission structure 310-4 of the optical transmission component 308-4 may be associated with the region 316. For example, the region 316 may include the two optical transmission structures 310-1-A and 310-1-B of the optical transmission component 308-1 and the one optical transmission structure 310-4 of the optical transmission component 308-4, such as where at least some of the corners of the region 316 are respectively defined to include (e.g., surround) the two optical transmission structures 310-1-A and 310-1-B of the optical transmission component 308-1 and the one optical transmission structure 310-4 of the optical transmission component 308-4. Accordingly, the region 316 may include at least portions of the layers 306 that include the two optical transmission structures 310-1-A and 310-1-B of the optical transmission component 308-1 and the one optical transmission structure 310-4 (e.g., the layers 306-2 and 306-8) and any layer in between (e.g., the layer 306-3 through 306-7). As further shown in FIG. 3B, the region 316 may surround the region 314.

As indicated above, FIGS. 3A-3C are provided as an example. Other examples may differ from what is described with regard to FIGS. 3A-3C. In practice, the photonic element 302 may include additional layers, components, and/or structures; fewer layers, components, and/or structures; different layers, components, and/or structures; or differently arranged layers, components, and/or structures than those shown in FIGS. 3A-3C.

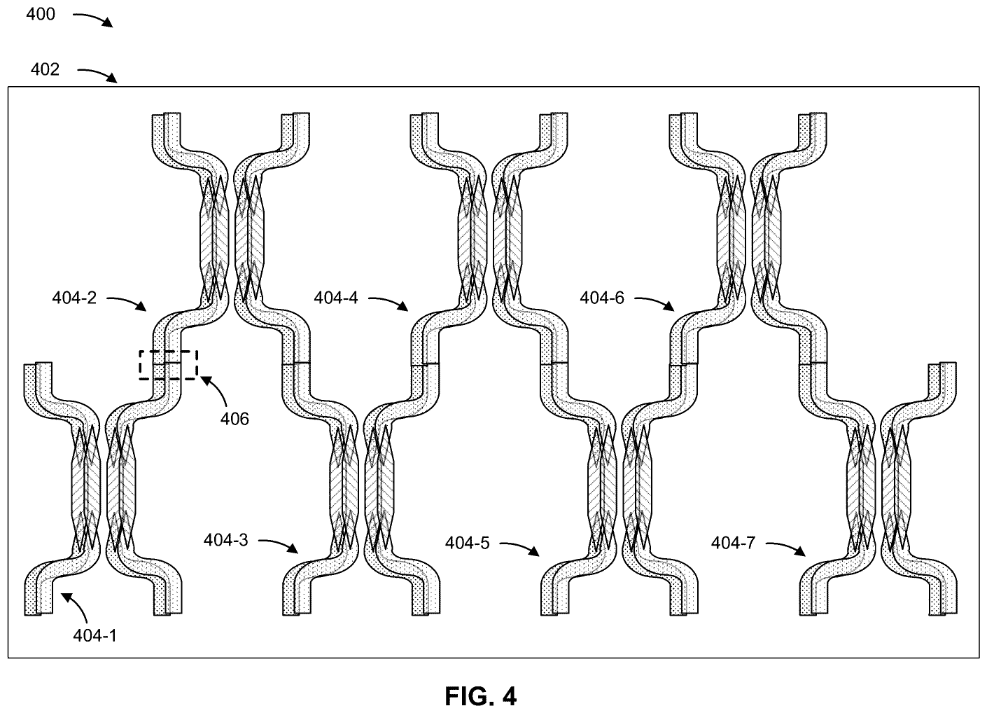

FIG. 4 shows an example 400 of a network 402 of a plurality of photonic elements 404 (shown as photonic elements 404-1 through 404-7) (e.g., from a top-down view). Each photonic element 404 may be the same as, or similar to, the photonic element 202 and/or the photonic element 302, described herein in relation to FIGS. 2A-2C and 3A-3C.

For example, the network 402 may comprise a substrate (e.g., that corresponds to the substrate 104 and/or the substrate 204), a first photonic element 404-1 that comprises four first optical transmission components (e.g., that correspond to the optical transmission components 208 and/or 308, described herein in relation to FIGS. 2A-2C and 3A-3C) in a first stack configuration in a first direction on a first region of the substrate, a second photonic element 404-2 that comprises four second optical transmission components (e.g., that correspond to the optical transmission components 208 and/or 308, described herein in relation to FIGS. 2A-2C and 3A-3C) in a second stack configuration in the first direction on a second region of the substrate, and so on. The four first optical transmission components may include two middle first optical transmission components that each include a pair of optical transmission structures (e.g., that correspond to the optical transmission structures 210 and/or 310, described herein in relation to FIGS. 2A-2C and 3A-3C), such that the pairs of optical transmission structures of the two middle first optical transmission components are arranged in a first quarter configuration; the four second optical transmission components may include two middle second optical transmission components that each include a pair of optical transmission structures described herein in relation to FIGS. 2A-2C and 3A-3C, such that the pairs of optical transmission structures of the two middle second optical transmission components are arranged in a second quarter configuration, and so on.

As shown in FIG. 4, the plurality of photonic elements 404 may be arranged in a two-dimensional arrangement, such as a two-dimensional array, within the network 402. As further shown in FIG. 4, a photonic element 404 may be connected to one or more other photonic elements 404. For example, for the first photonic element 404-1, the four first optical transmission components may include two end first optical transmission components, and, for first photonic element 404-2, the four second optical transmission components may include two end second optical transmission components. Accordingly, at least one of the end first optical transmission components may be connected to at least one of the end second optical transmission components, such as at region 406 shown in FIG. 4. Additionally, or alternatively, at least one of the end first optical transmission components may be configured to be evanescently coupled with each other (e.g., in a similar manner as that described herein), and therefore may not be physically connected.

In some implementations, the network 402 may include one or more modulation elements. Each modulation element may be configured to actively modulate (e.g., actively modulate) light that propagates through one or more optical transmission components of a photonic element 404. For example, each modulation element may include a resistive microheater (e.g., an integrated metal component that is configured to, based on an applied current, provide heat), a photonic heating element (e.g., that is configured to absorb other light and thereby provide heat), or another type of element to provide heat to at least a portion of one or more optical transmission components of a photonic element 404. By providing heat, the modulation element may adjust optical properties, such as refractive indexes, of the one or more optical transmission components of the photonic element 404, which can shift of a phase of light propagating via the one or more optical transmission components of the photonic element 404.

As indicated above, FIG. 4 are provided as an example. Other examples may differ from what is described with regard to FIG. 4. In practice, the network 402 may include additional photonic elements 404; fewer photonic elements 404; different photonic elements 404; or differently arranged photonic elements 404 than those shown in FIG. 4.

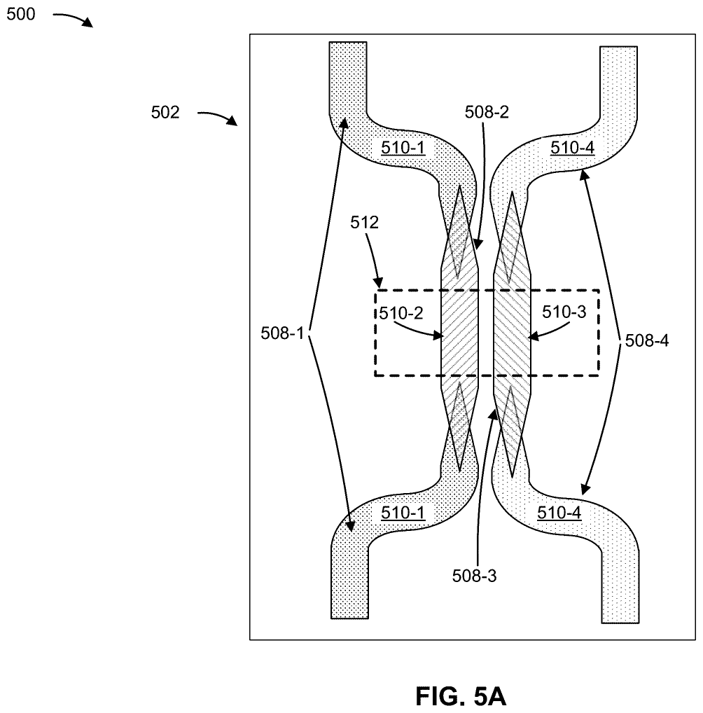

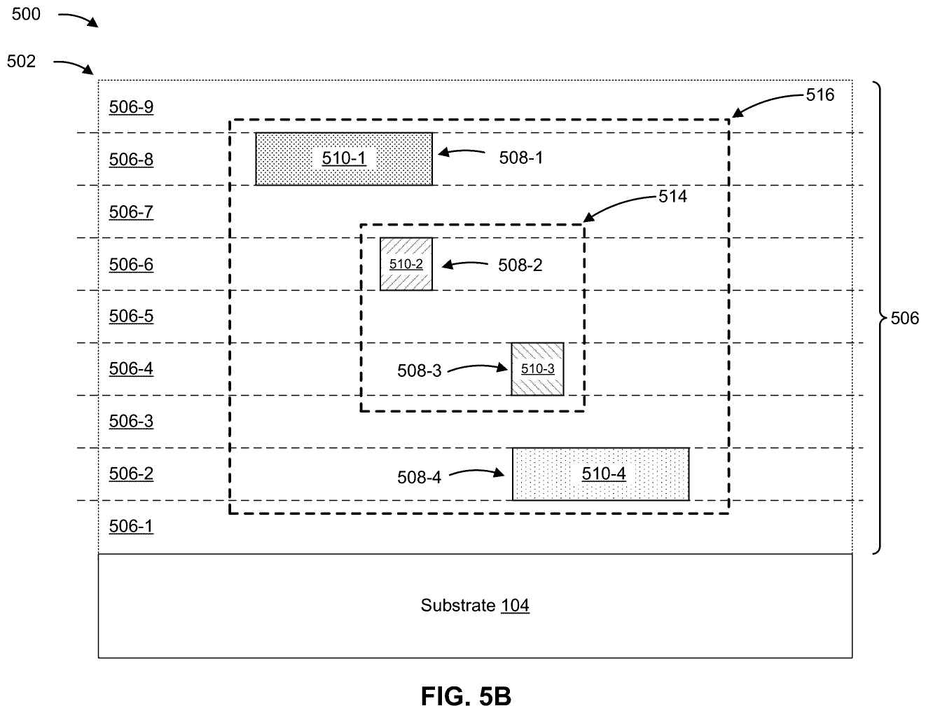

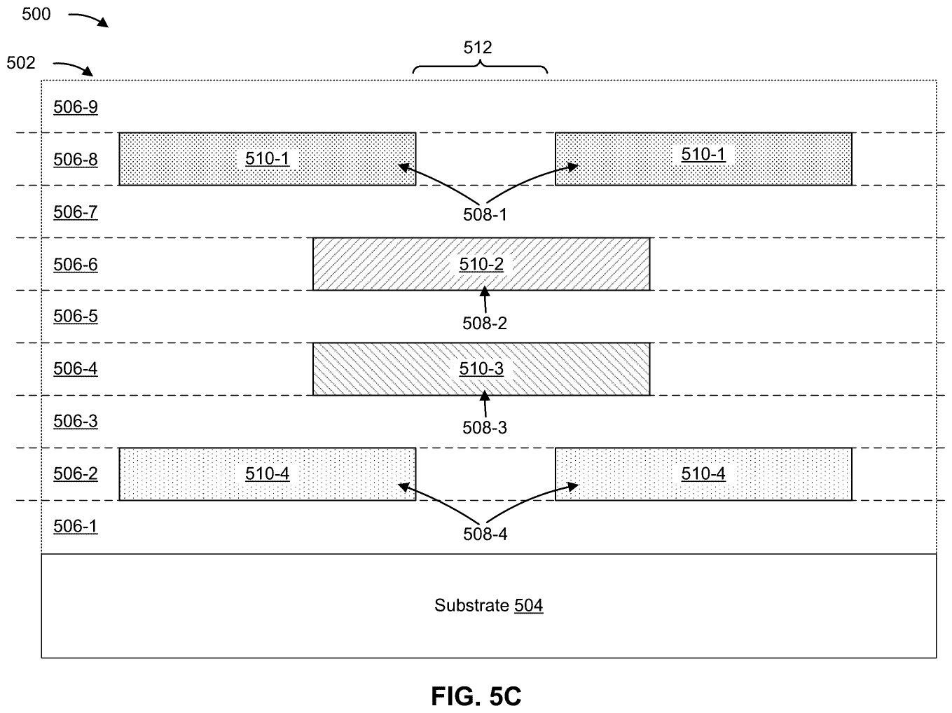

FIGS. 5A-5C show an example 500 of a photonic element 502. The photonic element 502 may be a photonic circuit, a unit cell, a PIC (e.g., that includes one or more interferometers), an optical logic gate, an optical switch, an optical amplifier, an optical modulator, and/or a frequency comb, among other examples. FIG. 5A shows a top-down view of the photonic element 502, FIG. 5B shows a first side view of the photonic element 502 (e.g., a view from a bottom side of the photonic element 502, as shown in FIG. 5A); and FIG. 5C shows a second side view of the photonic element 502 (e.g., a view from a left side of the photonic element 502, as shown in FIG. 5A).

As shown in FIGS. 5A-5C, the photonic element 502 may include a substrate 504, a plurality of layers 506 (shown as layers 506-1 through 506-9), and a plurality of optical transmission components 508 (shown as optical transmission components 508-1 through 508-4). The substrate 504, the plurality of layers 506, and the plurality of optical transmission components 508 may be the same as, or similar to, corresponding components described elsewhere herein.

The plurality of layers 506 may be disposed on the substrate 504, such as in a stack configuration (e.g., in a first direction) on the substrate 504. For example, as shown in FIGS. 5B-5C, the plurality of layers 506 (shown as layers 506-1 through 506-9) may be disposed in a stack configuration (e.g., in a vertical direction) on a top surface of the substrate 504. Accordingly, a particular layer 506 that is disposed over a first other layer 506 and below a second other layer 506 in the stack configuration, may be referred to as disposed between the first other layer 506 and the second other layer 506 in the stack configuration. Each layer 506, of the plurality of layers 506, may comprise a cladding material that include includes at least one of an oxide material (e.g., a silicon dioxide (SiO₂) material), a polymer material (e.g., a siloxane polymer material), a fluoride material (e.g., a magnesium fluoride (MgF₂) material, a calcium fluoride (CaF₂) material, or a lithium fluoride (LiF) material), or another material. In some implementations, a layer 506, such as a top layer (e.g., layer 506-9 shown in FIGS. 5B-5C) may comprise an air cladding.

Each optical transmission component 508 of the plurality of optical transmission components 508 may be configured to transmit light. For example, each optical transmission component 508 may be a waveguide, an interferometer, an optical switch, an optical resonator, and/or another optical transmission component. In some implementations, each optical transmission component 508 may comprise at least one of a non-alkali, oxide solution that includes a cation that is niobium, an alkali oxide material, an amorphous silicon (a-Si) material, a hydrogenated amorphous silicon (a-Si:H) material, a nitride-based material, an oxide-based material, or a semiconductor material, among other examples.

Each optical transmission component 508 may include one or more optical transmission structures 510. An optical transmission structure 510 may be a distinct portion of the optical transmission component 508. For example, as shown in FIG. 5A, an optical transmission component 508-1 (shown with dark gray shading) may include one optical transmission structure 510-1. An optical transmission structure 510 may have one or more discrete elements. For example, as shown in FIG. 5A, the optical transmission structure 510-1 may include a top element and a bottom element that are separated by a gap.

As further shown in FIG. 5A, an optical transmission component 508-2 (shown with left-to-right diagonal patterning) may include one optical transmission structures 510-2, where the optical transmission structure 510-2 comprises one discrete element; an optical transmission component 508-3 (shown with right-to-left diagonal patterning) may include one optical transmission structures 510-3, where the optical transmission structure 510-3 comprises one discrete element; and an optical transmission component 508-4 (shown with light gray shading) may include one optical transmission structure 510-4, where the optical transmission structure 510-4 comprises multiple discrete elements.

As shown in FIGS. 5A and 5C, the photonic element 502 may include a region 512 (e.g., a central region of the photonic element 502 in a second direction that is orthogonal to the first direction, such as in a horizontal direction). At least a portion of the optical transmission component 508-2 and/or at least a portion of the optical transmission component 508-3 may be associated with the region 512. For example, at least a portion of the one optical transmission structure 510 of the optical transmission component 508-2 and/or at least a portion of the one optical transmission structure 510-3 of the optical transmission component 508-3 may be present within the region 512. Additionally, or alternatively, no portion of the optical transmission component 508-1 and/or no portion of the optical transmission component 508-4 may be associated with the region 512. For example, no portion of the one optical transmission structure 510-1 of the optical transmission component 508-1 and/or the one optical transmission structure 510-4 of the optical transmission component 508-4 may be present within the region 512. This may be because of the respective gaps that separate the discrete elements of the optical transmission structure 510-1 and the discrete elements of the optical transmission structure 510-4.

Each optical transmission component 508 may be disposed in a particular layer of the plurality of layers 506. For example, as shown in FIGS. 5B and 5C, the optical transmission component 508-1 may be disposed in the layer 506-8 (e.g., the one optical transmission structures 510-1 may be disposed in the layer 506-8), the optical transmission component 508-2 may be disposed in the layer 506-6 (e.g., the one optical transmission structure 510-2 may be disposed in the layer 506-6), the optical transmission component 508-3 may be disposed in the layer 506-4 (e.g., the one optical transmission structure 510-3 may be disposed in the layer 506-4), and the optical transmission component 508-4 may be disposed in the layer 506-2 (e.g., the one optical transmission structure 510-4 may be disposed in the layer 506-2). Accordingly, as shown in FIGS. 5B-5C, a layer 506, of the plurality of layers 506, may include a particular optical transmission component 508, or may not include any optical transmission component 508.

As shown in FIG. 5B, the one optical transmission structure 510-2 of the optical transmission component 508-2 and the one optical transmission structure 510-3 of the optical transmission component 508-3 may be arranged in a “non-aligned vertical” configuration. For example, the optical transmission structure 510-2 and the one optical transmission structure 510-3 may be disposed in different layers (e.g., the layers 506-6 and 506-4, respectively), and the optical transmission structure 510-2 and the optical transmission structure 510-3 may not be aligned in the first direction (e.g., the vertical direction shown in FIG. 5B). That is, no line that is parallel (e.g., within a tolerance, such as 1 degree, 2 degrees, or 3 degrees) to the first direction passes through both of the optical transmission structure 510-2 and the optical transmission structure 510-3.

In some implementations, the optical transmission structure 510-2 of the optical transmission component 508-2 and the optical transmission structure 510-3 of the optical transmission component 508-3 may be configured to be evanescently coupled with each other. For example, the optical transmission structure 510-2 of the optical transmission component 508-2 and the optical transmission structure 510-3 of the optical transmission component 508-3 may be spaced within a threshold distance of each other to enable evanescent coupling. Additionally, or alternatively, the optical transmission structure 510-2 of the optical transmission component 508-2 and the optical transmission structure 510-1 of the optical transmission component 508-1 may be configured to be evanescently coupled with each other and/or the optical transmission structure 510-3 of the optical transmission component 508-3 and the optical transmission structure 510-4 of the optical transmission component 508-4 be configured to be evanescently coupled with each other.

As further shown in FIG. 5B, the photonic element 502 may include a region 514 (e.g., a quadrilateral region of the photonic element 502 in the first direction). The one optical transmission structure 510-2 of the optical transmission component 508-2 and the one optical transmission structure 510-3 may be associated with the region 514. For example, the region 514 may include the optical transmission structure 510-2 of the optical transmission component 508-2 and the optical transmission structures 510-3 of the optical transmission component 508-3, where corners of the region 514 are respectively defined to include (e.g., surround) the optical transmission structure 510-2 of the optical transmission component 508-2 and the optical transmission structure 510-3 of the optical transmission component 508-3. Accordingly, the region 514 may include at least portions of the layers 506 that include the optical transmission structure 510-2 of the optical transmission component 508-2 and the optical transmission structure 510-3 (e.g., the layers 506-6 and 506-4) and any layer in between (e.g., the layer 506-5).

As further shown in FIG. 5B, the photonic element 502 may include a region 516 (e.g., a quadrilateral region of the photonic element 502 in the first direction). The one optical transmission structure 510-1 of the optical transmission component 508-1 and the one optical transmission structure 510-4 of the optical transmission component 508-4 may be associated with the region 516. For example, the region 516 may include the optical transmission structure 510-1 of the optical transmission component 508-1 and the one optical transmission structure 510-4 of the optical transmission component 508-4, such as where corners of the region 516 are respectively defined to include (e.g., surround) the optical transmission structure 510-1 of the optical transmission component 508-1 and the one optical transmission structure 510-4 of the optical transmission component 508-4. Accordingly, the region 516 may include at least portions of the layers 506 that include the optical transmission structure 510-1 of the optical transmission component 508-1 and the one optical transmission structure 510-4 of the optical transmission component 508-4 (e.g., the layers 506-2 and 506-8) and any layer in between (e.g., the layer 506-3 through 506-7). As further shown in FIG. 5B, the region 516 may surround the region 514.

As indicated above, FIGS. 5A-5C are provided as an example. Other examples may differ from what is described with regard to FIGS. 5A-5C. In practice, the photonic element 502 may include additional layers, components, and/or structures; fewer layers, components, and/or structures; different layers, components, and/or structures; or differently arranged layers, components, and/or structures than those shown in FIGS. 5A-5C.

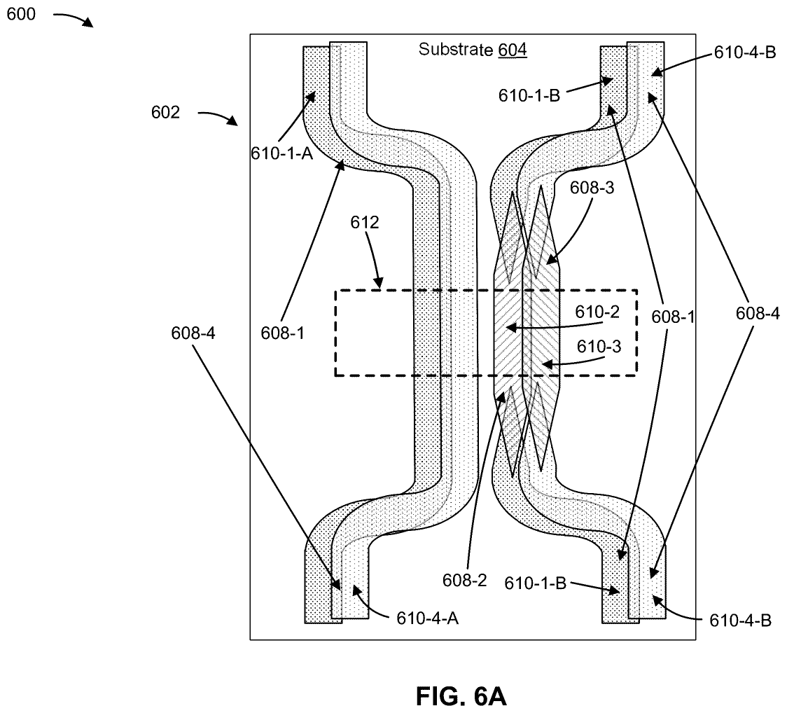

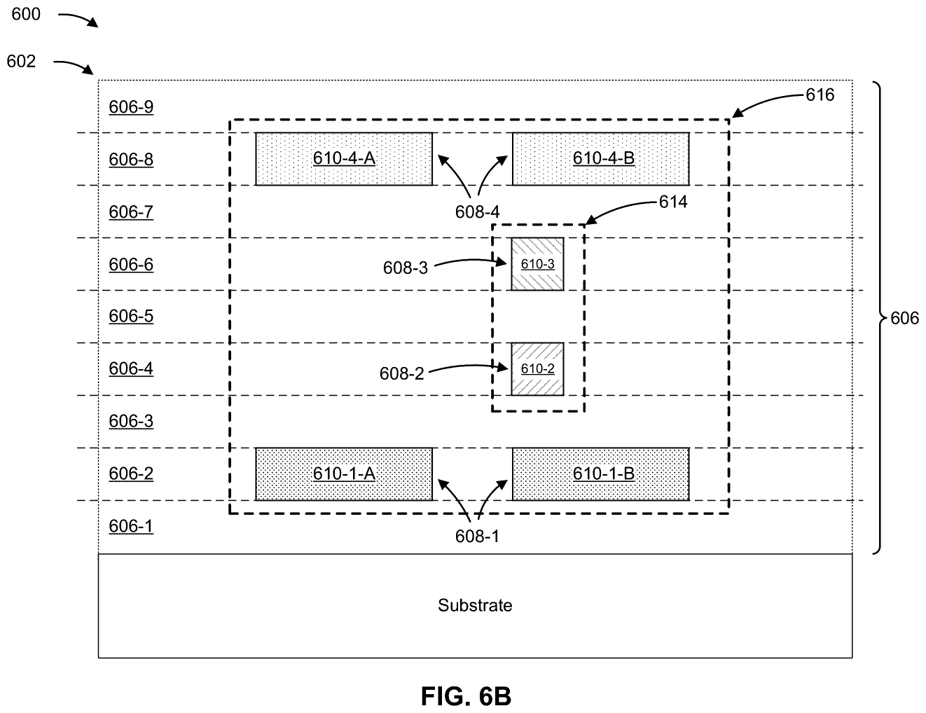

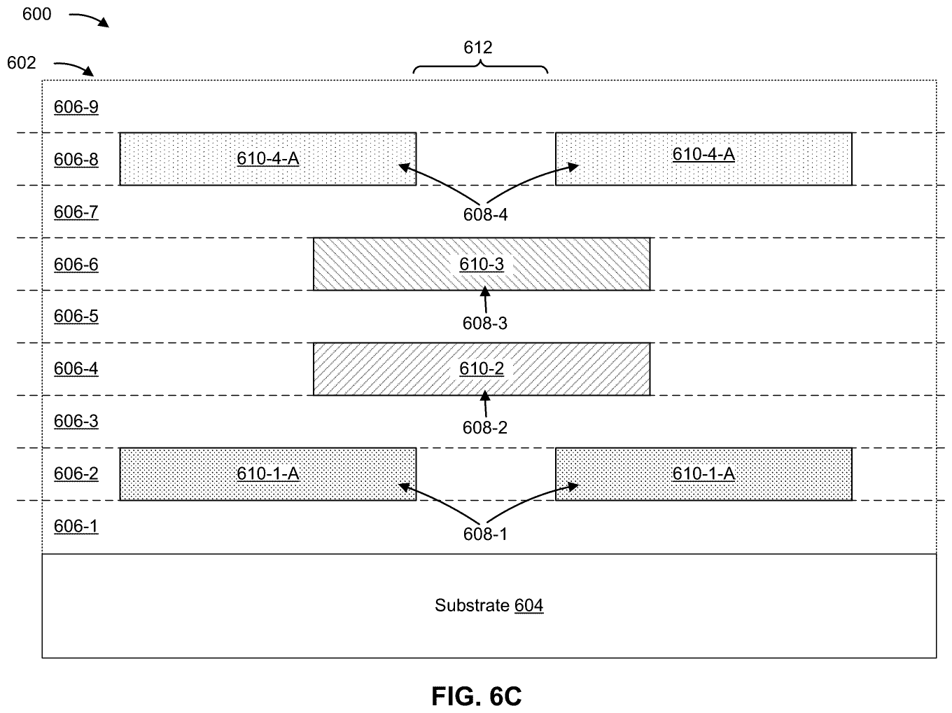

FIGS. 6A-6C show an example 600 of a photonic element 602. The photonic element 602 may be a photonic circuit, a unit cell, a PIC (e.g., that includes one or more interferometers), an optical logic gate, an optical switch, an optical amplifier, an optical modulator, and/or a frequency comb, among other examples. FIG. 6A shows a top-down view of the photonic element 602, FIG. 6B shows a first side view of the photonic element 602 (e.g., a view from a bottom side of the photonic element 602, as shown in FIG. 6A); and FIG. 6C shows a second side view of the photonic element 602 (e.g., a view from a left side of the photonic element 602, as shown in FIG. 6A).

As shown in FIGS. 6A-6C, the photonic element 602 may include a substrate 604, a plurality of layers 606 (shown as layers 606-1 through 606-9), and a plurality of optical transmission components 608 (shown as optical transmission components 608-1 through 608-4). The substrate 604, the plurality of layers 606, and the plurality of optical transmission components 608 may be the same as, or similar to, corresponding components described elsewhere herein.

The plurality of layers 606 may be disposed on the substrate 604, such as in a stack configuration (e.g., in a first direction) on the substrate 604. For example, as shown in FIGS. 6B-6C, the plurality of layers 606 (shown as layers 606-1 through 606-9) may be disposed in a stack configuration (e.g., in a vertical direction) on a top surface of the substrate 604. Accordingly, a particular layer 606 that is disposed over a first other layer 606 and below a second other layer 606 in the stack configuration, may be referred to as disposed between the first other layer 606 and the second other layer 606 in the stack configuration. Each layer 606, of the plurality of layers 606, may comprise a cladding material that include includes at least one of an oxide material (e.g., a silicon dioxide (SiO₂) material), a polymer material (e.g., a siloxane polymer material), a fluoride material (e.g., a magnesium fluoride (MgF₂) material, a calcium fluoride (CaF₂) material, or a lithium fluoride (LiF) material), or another material. In some implementations, a layer 606, such as a top layer (e.g., layer 606-9 shown in FIGS. 6B-6C) may comprise an air cladding.

Each optical transmission component 608 of the plurality of optical transmission components 608 may be configured to transmit light. For example, each optical transmission component 608 may be a waveguide, an interferometer, an optical switch, an optical resonator, and/or another optical transmission component. In some implementations, each optical transmission component 608 may comprise at least one of a non-alkali, oxide solution that includes a cation that is niobium, an alkali oxide material, an amorphous silicon (a-Si) material, a hydrogenated amorphous silicon (a-Si:H) material, a nitride-based material, an oxide-based material, or a semiconductor material, among other examples.

Each optical transmission component 608 may include one or more optical transmission structures 610. An optical transmission structure 610 may be a distinct portion of the optical transmission component 608. For example, as shown in FIG. 6A, an optical transmission component 608-1 (shown with dark gray shading) may include two optical transmission structures 610-1: a first optical transmission structure 610-1-A (shown as a left optical transmission structure) and a second optical transmission structure 610-1-B (shown as a right optical transmission structure). An optical transmission structure 610 may have one or more discrete elements. For example, as shown in FIG. 6A, the first optical transmission structure 610-1-A may include a one discrete element that are separated by a gap, and the second optical transmission structure 610-1-B may include a top element and a bottom element that are separated by a gap.

As further shown in FIG. 6A, an optical transmission component 608-2 (shown with left-to-right diagonal patterning) may include one optical transmission structure 610-2, where the optical transmission structure 610-2 comprises one discrete element; an optical transmission component 608-3 (shown with right-to-left diagonal patterning) may include one optical transmission structure 610-3, where each optical transmission structure 610-3 comprises one discrete element; and an optical transmission component 608-4 (shown with light gray shading) may include two optical transmission structures 610-4: a first optical transmission structure 610-4-A (shown as a left optical transmission structure) and a second optical transmission structure 610-4-B (shown as a right optical transmission structure), where the first optical transmission structure 610-4-A comprises one discrete element and the second optical transmission structure 610-4-B comprises multiple discrete elements.

As shown in FIGS. 6A and 6C, the photonic element 602 may include a region 612 (e.g., a central region of the photonic element 602 in a second direction that is orthogonal to the first direction, such as in a horizontal direction). At least a portion of the optical transmission component 608-2 and/or at least a portion of the optical transmission component 608-3 may be associated with the region 612. For example, at least a portion of the optical transmission structure 610-2 of the optical transmission component 608-2 and/or at least a portion of the optical transmission structure 610-3 of the optical transmission component 608-3 may be present within the region 612.

Each optical transmission component 608 may be disposed in a particular layer of the plurality of layers 606. For example, as shown in FIGS. 6B and 6C, the optical transmission component 608-1 may be disposed in the layer 606-2 (e.g., the two optical transmission structures 610-1-A and 610-1-B may be disposed in the layer 606-2), the optical transmission component 608-2 may be disposed in the layer 606-4 (e.g., the optical transmission structure 610-2 may be disposed in the layer 606-4), the optical transmission component 608-3 may be disposed in the layer 606-6 (e.g., the optical transmission structures 610-3 may be disposed in the layer 606-6), and the optical transmission component 608-4 may be disposed in the layer 606-8 (e.g., the two optical transmission structures 610-4-A and 610-4-B may be disposed in the layer 606-8). Accordingly, as shown in FIGS. 6B-6C, a layer 606, of the plurality of layers 606, may include a particular optical transmission component 608, or may not include any optical transmission component 608.

As shown in FIG. 6B, the one optical transmission structure 610-2 of the optical transmission component 608-2 and the one optical transmission structure 610-3 of the optical transmission component 608-3 may be arranged in an “aligned vertical” configuration. For example, the optical transmission structure 610-2 and the one optical transmission structure 610-3 may be disposed in different layers (e.g., the layers 606-4 and 606-6, respectively), and the optical transmission structure 610-2 and the optical transmission structure 610-3 may be aligned in the first direction (e.g., the vertical direction shown in FIG. 6B).

In some implementations, the optical transmission structure 610-2 and the optical transmission structure 610-3 may be configured to be evanescently coupled with each other. For example, the optical transmission structure 610-2 and the optical transmission structure 610-3 may be spaced within a threshold distance of each other to enable evanescent coupling. Additionally, or alternatively, the optical transmission structure 610-2 and the two optical transmission structures 610-1-A and 610-1-B of the optical transmission component 608-1 may be configured to be evanescently coupled with each other and/or the optical transmission structure 610-3 and the two optical transmission structures 610-4-A and 610-4-B of the optical transmission component 608-4 may be configured to be evanescently coupled with each other.

As further shown in FIG. 6B, the photonic element 602 may include a region 614 (e.g., a quadrilateral region of the photonic element 602 in the first direction). The one optical transmission structures 610-2 of the optical transmission component 608-2 and the one optical transmission structures 610-3 of the optical transmission component 608-3 may be associated with the region 614. For example, the region 614 may include the optical transmission structure 610-2 and the optical transmission structure 610-3, where corners of the region 614 are respectively defined to include (e.g., surround) the optical transmission structure 610-2 and the optical transmission structure 610-3. Accordingly, the region 614 may include at least portions of the layers 606 that include the optical transmission structure 610-2 and the optical transmission structure 610-3 (e.g., the layers 606-4 and 606-6) and any layer in between (e.g., the layer 606-5).

As further shown in FIG. 6B, the photonic element 602 may include a region 616 (e.g., a quadrilateral region of the photonic element 602 in the first direction). The two optical transmission structures 610-1-A and 610-1-B of the optical transmission component 608-1 and the two optical transmission structures 610-4-A and 610-4-B of the optical transmission component 608-4 may be associated with the region 616. For example, the region 616 may include the two optical transmission structures 610-1-A and 610-1-B of the optical transmission component 608-1 and the two optical transmission structures 610-4-A and 610-4-B of the optical transmission component 608-4, such as where corners of the region 616 are respectively defined to include (e.g., surround) the two optical transmission structures 610-1-A and 610-1-B of the optical transmission component 608-1 and the two optical transmission structures 610-4-A and 610-4-B of the optical transmission component 608-4. Accordingly, the region 616 may include at least portions of the layers 606 that include the two optical transmission structures 610-1-A and 610-1-B of the optical transmission component 608-1 and the two optical transmission structures 610-4-A and 610-4-B (e.g., the layers 606-2 and 606-8) and any layer in between (e.g., the layer 606-3 through 606-7). As further shown in FIG. 6B, the region 616 may surround the region 614.

As indicated above, FIGS. 6A-6C are provided as an example. Other examples may differ from what is described with regard to FIGS. 6A-6C. In practice, the photonic element 602 may include additional layers, components, and/or structures; fewer layers, components, and/or structures; different layers, components, and/or structures; or differently arranged layers, components, and/or structures than those shown in FIGS. 6A-6C.

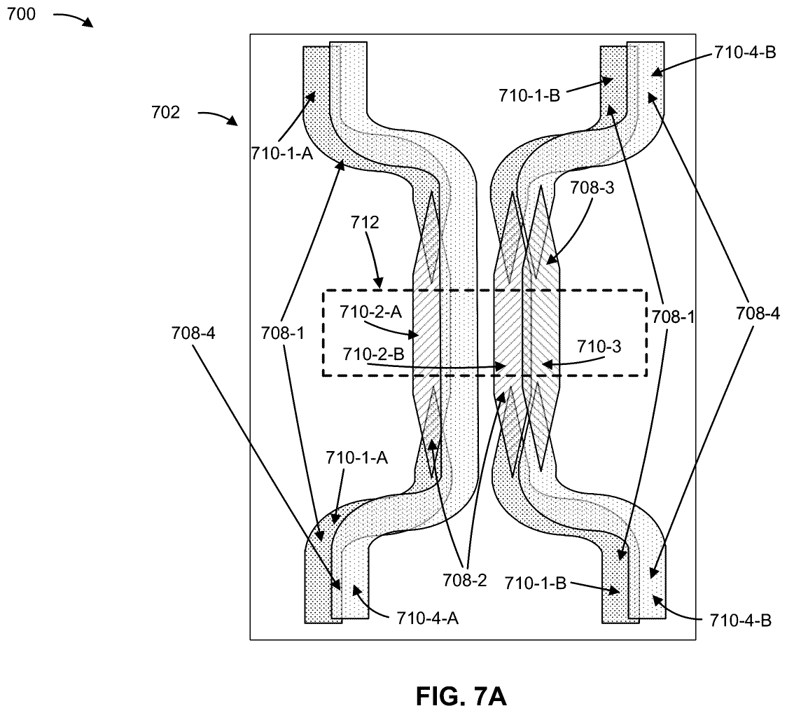

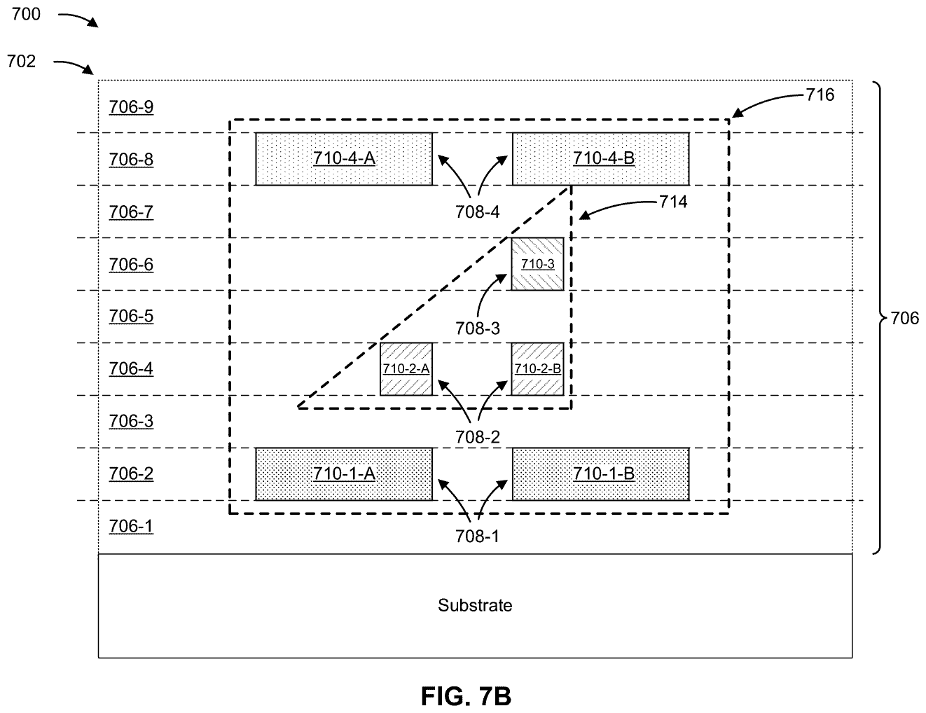

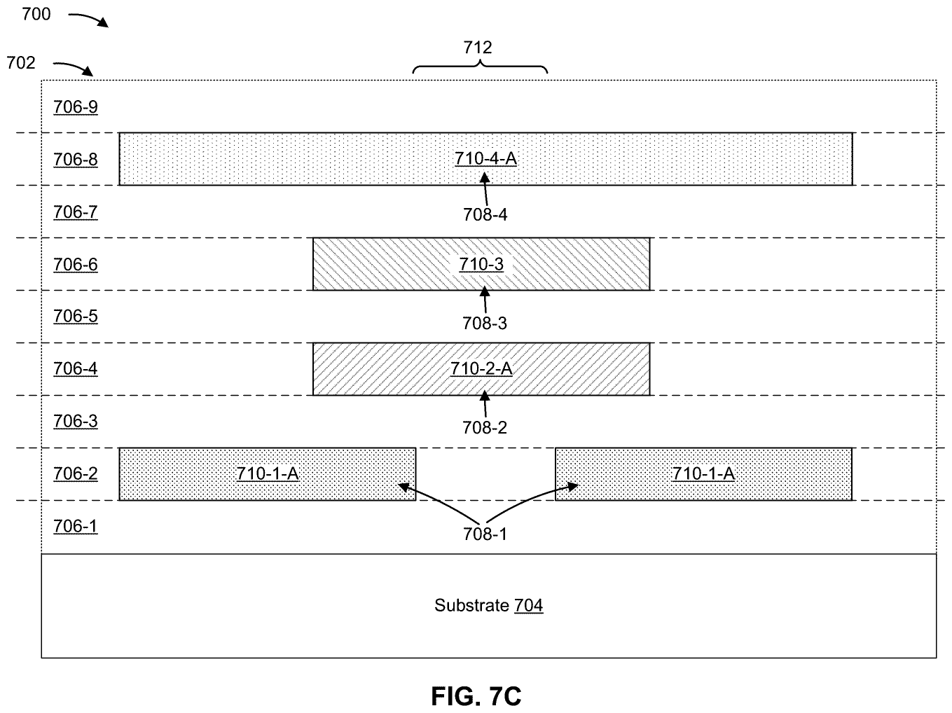

FIGS. 7A-7C show an example 700 of a photonic element 702. The photonic element 702 may be a photonic circuit, a unit cell, a PIC (e.g., that includes one or more interferometers), an optical logic gate, an optical switch, an optical amplifier, an optical modulator, and/or a frequency comb, among other examples. FIG. 7A shows a top-down view of the photonic element 702, FIG. 7B shows a first side view of the photonic element 702 (e.g., a view from a bottom side of the photonic element 702, as shown in FIG. 7A); and FIG. 7C shows a second side view of the photonic element 702 (e.g., a view from a left side of the photonic element 702, as shown in FIG. 7A).

As shown in FIGS. 7A-7C, the photonic element 702 may include a substrate 704, a plurality of layers 706 (shown as layers 706-1 through 706-9), and a plurality of optical transmission components 708 (shown as optical transmission components 708-1 through 708-4). The substrate 704, the plurality of layers 706, and the plurality of optical transmission components 708 may be the same as, or similar to, corresponding components described elsewhere herein.

The plurality of layers 706 may be disposed on the substrate 704, such as in a stack configuration (e.g., in a first direction) on the substrate 704. For example, as shown in FIGS. 7B-7C, the plurality of layers 706 (shown as layers 706-1 through 706-9) may be disposed in a stack configuration (e.g., in a vertical direction) on a top surface of the substrate 704. Accordingly, a particular layer 706 that is disposed over a first other layer 706 and below a second other layer 706 in the stack configuration, may be referred to as disposed between the first other layer 706 and the second other layer 706 in the stack configuration. Each layer 706, of the plurality of layers 706, may comprise a cladding material that include includes at least one of an oxide material (e.g., a silicon dioxide (SiO₂) material), a polymer material (e.g., a siloxane polymer material), a fluoride material (e.g., a magnesium fluoride (MgF₂) material, a calcium fluoride (CaF₂) material, or a lithium fluoride (LiF) material), or another material. In some implementations, a layer 706, such as a top layer (e.g., layer 706-9 shown in FIGS. 7B-7C) may comprise an air cladding.

Each optical transmission component 708 of the plurality of optical transmission components 708 may be configured to transmit light. For example, each optical transmission component 708 may be a waveguide, an interferometer, an optical switch, an optical resonator, and/or another optical transmission component. In some implementations, each optical transmission component 708 may comprise at least one of a non-alkali, oxide solution that includes a cation that is niobium, an alkali oxide material (e.g., that includes at least lithium niobate, barium titanate, and/or another alkali oxide material), an amorphous silicon (a-Si) material, a hydrogenated amorphous silicon (a-Si:H) material, a nitride-based material, an oxide-based material, or a semiconductor material, among other examples.

Each optical transmission component 708 may include one or more optical transmission structures 710. An optical transmission structure 710 may be a distinct portion of the optical transmission component 708. For example, as shown in FIG. 7A, an optical transmission component 708-1 (shown with dark gray shading) may include two optical transmission structures 710-1: a first optical transmission structure 710-1-A (shown as a left optical transmission structure) and a second optical transmission structure 710-1-B (shown as a right optical transmission structure). An optical transmission structure 710 may have one or more discrete elements. For example, as shown in FIG. 7A, the first optical transmission structure 710-1-A may include a top element and a bottom element that are separated by a gap, and the second optical transmission structure 710-1-B may include a top element and a bottom element that are separated by a gap.

As further shown in FIG. 7A, an optical transmission component 708-2 (shown with left-to-right diagonal patterning) may include two optical transmission structures 710-2: a first optical transmission structure 710-2-A (shown as a left optical transmission structure) and a second optical transmission structure 710-2-B (shown as a right optical transmission structure), where each optical transmission structure 710-2 comprises one discrete element; an optical transmission component 708-3 (shown with right-to-left diagonal patterning) may include one optical transmission structure 710-3, where the optical transmission structure 710-3 comprises one discrete element; and an optical transmission component 708-4 (shown with light gray shading) may include two optical transmission structures 710-4: a first optical transmission structure 710-4-A (shown as a left optical transmission structure) and a second optical transmission structure 710-4-B (shown as a right optical transmission structure), where the first optical transmission structure 710-4-A comprises one discrete element and the second optical transmission structure 710-4-B comprises multiple discrete elements.

As shown in FIGS. 7A and 7C, the photonic element 702 may include a region 712 (e.g., a central region of the photonic element 702 in a second direction that is orthogonal to the first direction, such as in a horizontal direction). At least a portion of the optical transmission component 708-2 and/or at least a portion of the optical transmission component 708-3 may be associated with the region 712. For example, at least a portion of the two optical transmission structures 710-2-A and 710-2-B of the optical transmission component 708-2 and/or at least a portion of the one optical transmission structures 710-3 of the optical transmission component 708-3 may be present within the region 712. Additionally, or alternatively, no portion of the optical transmission component 708-1 and/or no portion of the optical transmission component 708-4 may be associated with the region 712. For example, no portion of the two optical transmission structures 710-1-A and 710-1-B of the optical transmission component 708-1 may be present within the region 712. This may be because of the respective gaps that separate the discrete elements of the first optical transmission structure 710-1-A and the discrete elements of the second optical transmission structure 710-1-B.

Each optical transmission component 708 may be disposed in a particular layer of the plurality of layers 706. For example, as shown in FIGS. 7B and 7C, the optical transmission component 708-1 may be disposed in the layer 706-2 (e.g., the two optical transmission structures 710-1-A and 710-1-B may be disposed in the layer 706-2), the optical transmission component 708-2 may be disposed in the layer 706-4 (e.g., the two optical transmission structures 710-2-A and 710-2-B may be disposed in the layer 706-4), the optical transmission component 708-3 may be disposed in the layer 706-6 (e.g., the one optical transmission structure 710-3 may be disposed in the layer 706-6), and the optical transmission component 708-4 may be disposed in the layer 706-8 (e.g., the two optical transmission structures 710-4-A and 710-4-B may be disposed in the layer 706-8). Accordingly, as shown in FIGS. 7B-7C, a layer 706, of the plurality of layers 706, may include a particular optical transmission component 708, or may not include any optical transmission component 708.

As shown in FIG. 7B, the two optical transmission structures 710-2-A and 710-2-B of the optical transmission component 708-2 and the one optical transmission structure 710-3 of the optical transmission component 708-3 may be arranged in an “offset triter” configuration. For example, the two optical transmission structures 710-2-A and 710-2-B may be disposed in a first layer (e.g., the layer 706-4) and the and the optical transmission structure 710-3 may be disposed in a second layer (e.g., the layer 706-6), and the optical transmission structure 710-3 may be aligned in the first direction (e.g., the vertical direction shown in FIG. 7B) with one of the two optical transmission structures 710-2-A and 710-2-B.

In some implementations, the two optical transmission structures 710-2-A and 710-2-B of the optical transmission component 708-2 and the one optical transmission structure 710-3 of the optical transmission component 708-3 may be configured to be evanescently coupled with each other. For example, the two optical transmission structures 710-2-A and 710-2-B of the optical transmission component 708-2 and the optical transmission structure 710-3 of the optical transmission component 708-3 may be spaced within a threshold distance of each other to enable evanescent coupling. Additionally, or alternatively, the two optical transmission structures 710-2-A and 710-2-B of the optical transmission component 708-2 and the two optical transmission structures 710-1-A and 710-1-B of the optical transmission component 708-1 may be configured to be evanescently coupled with each other and/or the optical transmission structure 710-3 of the optical transmission component 708-3 and the two optical transmission structures 710-4-A and 710-4-B of the optical transmission component 708-4 may be configured to be evanescently coupled with each other.

As further shown in FIG. 7B, the photonic element 702 may include a region 714 (e.g., a triangle region of the photonic element 702 in the first direction). The two optical transmission structures 710-2-A and 710-2-B of the optical transmission component 708-2 and the one optical transmission structure 710-3 of the optical transmission component 708-3 may be associated with the region 714. For example, the region 714 may include the two optical transmission structures 710-2-A and 710-2-B of the optical transmission component 708-2 and the optical transmission structure 710-3 of the optical transmission component 708-3, where corners of the region 714 are respectively defined to include (e.g., surround) the two optical transmission structures 710-2-A and 710-2-B of the optical transmission component 708-2 and the optical transmission structure 710-3 of the optical transmission component 708-3. Accordingly, the region 714 may include at least portions of the layers 706 that include the two optical transmission structures 710-2-A and 710-2-B of the optical transmission component 708-2 and the optical transmission structure 710-3 of the optical transmission component 708-3 (e.g., the layers 706-4 and 706-6) and any layer in between (e.g., the layer 706-5).

As further shown in FIG. 7B, the photonic element 702 may include a region 716 (e.g., a quadrilateral region of the photonic element 702 in the first direction). The two optical transmission structures 710-1-A and 710-1-B of the optical transmission component 708-1 and the two optical transmission structures 710-4-A and 710-4-B of the optical transmission component 708-4 may be associated with the region 716. For example, the region 716 may include the two optical transmission structures 710-1-A and 710-1-B of the optical transmission component 708-1 and the two optical transmission structures 710-4-A and 710-4-B of the optical transmission component 708-4, such as where corners of the region 716 are respectively defined to include (e.g., surround) the two optical transmission structures 710-1-A and 710-1-B of the optical transmission component 708-1 and the two optical transmission structures 710-4-A and 710-4-B of the optical transmission component 708-4. Accordingly, the region 716 may include at least portions of the layers 706 that include the two optical transmission structures 710-1-A and 710-1-B of the optical transmission component 708-1 and the two optical transmission structures 710-4-A and 710-4-B (e.g., the layers 706-2 and 706-8) and any layer in between (e.g., the layer 706-3 through 706-7). As further shown in FIG. 7B, the region 716 may surround the region 714.

As indicated above, FIGS. 7A-7C are provided as an example. Other examples may differ from what is described with regard to FIGS. 7A-7C. In practice, the photonic element 702 may include additional layers, components, and/or structures; fewer layers, components, and/or structures; different layers, components, and/or structures; or differently arranged layers, components, and/or structures than those shown in FIGS. 7A-7C.

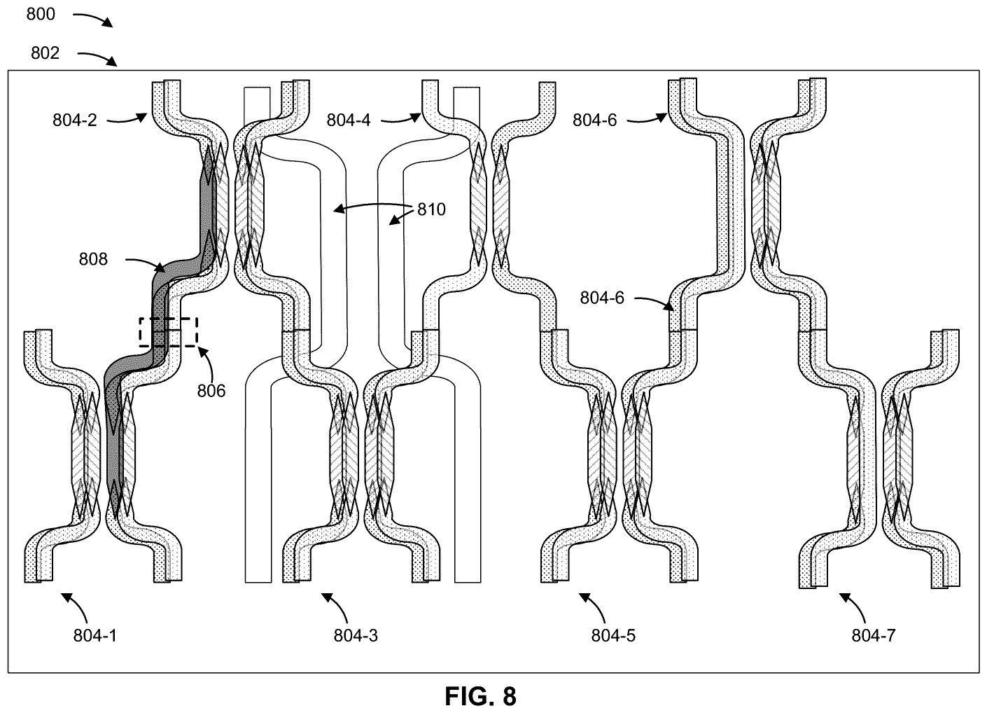

FIG. 8 shows an example 800 of a network 802 of a plurality of photonic elements 804 (shown as photonic elements 804-1 through 804-7) (e.g., from a top-down view). Each photonic element 804 may be the same as, or similar to, at least one of the photonic elements 202, 302, 502, 602, and/or 702 described herein in relation to FIGS. 2A-2C, 3A-3C, 5A-5C, 6A-6C, and 7A-7C.

For example, the network 802 may comprise a substrate (e.g., that corresponds to at least one of the substrates 104, 204, 304, 504, 604, and/or 704, described herein in relation to FIGS. 2A-2C, 3A-3C, 5A-5C, 6A-6C, and 7A-7C), and a plurality of photonic elements 804 disposed on respective regions of the substrate. Each photonic element 804 may include a first optical transmission component, a second optical transmission component, a third optical transmission component, and a fourth optical transmission component in a stack configuration (e.g., that each correspond to at least one of the optical transmission components 208, 308, 508, 608, and/or 708, described herein in relation to FIGS. 2A-2C, 3A-3C, 5A-5C, 6A-6C, and 7A-7C).

Each of the first optical transmission component, the second optical transmission component, the third optical transmission component, and the fourth optical transmission component may include one or more optical transmission structures (e.g., that correspond to at least one of the optical transmission structures 210, 310, 510, 610, and/or 710, described herein in relation to FIGS. 2A-2C, 3A-3C, 5A-5C, 6A-6C, and 7A-7C). The second optical transmission component and the third optical transmission component may each be disposed between the first optical transmission component and the fourth optical transmission component in the stack configuration. For example, the first optical transmission component, the second optical transmission component, the third optical transmission component, and the fourth optical transmission component may be respectively disposed in a plurality of layers that are disposed on the substrate, wherein the first optical transmission component and the fourth optical transmission component are disposed in end layers and the second optical transmission component and the third optical transmission component are disposed in middle layers that are between the end layers.

As shown in FIG. 8, the plurality of photonic elements 804 may be arranged in a two-dimensional arrangement, such as a two-dimensional array, within the network 802. Each photonic element 804 may be associated with a particular optical transmission component configuration (e.g., that is one of a quarter configuration, a triter configuration, an offset triter configuration, an aligned vertical configuration, or a non-aligned vertical configuration, or another configuration, as described herein in relation to FIGS. 2A-2C, 3A-3C, 5A-5C, 6A-6C, and 7A-7C).

In some implementations, a first photonic element 804 may be associated with a first optical transmission component and a second photonic element 804 may be associated with a second optical transmission component that is different than the first optical transmission component. For example, as shown in FIG. 8, a photonic element 804-4 may be associated with a non-aligned vertical configuration (e.g., the photonic element 804-4 may be the same as, or similar to, the photonic element 502 described herein in relation to FIGS. 5A-5C), a photonic element 804-5 may be associated with a quarter configuration (e.g., the photonic element 804-5 may be the same as, or similar to, the photonic element 202 described herein in relation to FIGS. 2A-2C), a photonic element 804-6 may be associated with an aligned vertical configuration (e.g., the photonic element 804-6 may be the same as, or similar to, the photonic element 602 described herein in relation to FIGS. 6A-6C), and a photonic element 804-7 may be associated with an offset triter configuration (e.g., the photonic element 804-7 may be the same as, or similar to, the photonic element 702 described herein in relation to FIGS. 7A-7C).

As further shown in FIG. 8, a photonic element 804 may be connected to one or more other photonic elements 804. For example, at least one optical transmission component of a photonic element 804-1 may be connected to at least one optical transmission component of a photonic element 804-2, such as at region 806 shown in FIG. 8. Additionally, or alternatively at least one optical transmission component of a photonic element 804-1 and at least one optical transmission component of a photonic element 804-2 may be configured to be evanescently coupled with each other (e.g., in a similar manner as that described herein), and therefore may not be physically connected.

In some implementations, an optical transmission component 808 (indicated by dark gray shading) may be included in more than one photonic element 804. That is, the optical transmission component 808 (e.g., that corresponds to at least one of the optical transmission components 208, 308, 508, 608, and/or 708, described herein in relation to FIGS. 2A-2C, 3A-3C, 5A-5C, 6A-6C, and 7A-7C) may extend (e.g., within a layer) from one photonic element 804 to at least one other photonic element 804. For example, as shown in FIG. 8, the optical transmission component 808 may be included in optical transmission components 804-1 and 804-2.

In some implementations, the network 802 may include one or more other optical transmission components 810 (e.g., that are not included in the photonic elements 804). The one or more other optical transmission components 810 may be disposed on the substrate, such as on one or more regions that are also associated with respective photonic elements 804. For example, as shown in FIG. 8, an optical transmission component 810 be disposed on the substrate on one or more regions associated with the photonic elements 804-2, 804-3, and 804-4. The one or more optical transmission components 810 may be disposed in at least one different layer, of the plurality of layers disposed on the substrate, than that in which optical transmission components of the photonic elements 804 are disposed. For example, as shown in FIG. 8, the optical transmission component 810 is shown as being disposed in a layer that is “under” layers in which the photonic elements 804-2, 804-3, and 804-4 are disposed.

In some implementations, the network 802 may include one or more modulation elements. Each modulation element may be configured to modulate (e.g., actively modulate) light that propagates through one or more optical transmission components of a photonic element 804. For example, each modulation element may include a resistive microheater (e.g., an integrated metal component that is configured to, based on an applied current, provide heat), a photonic heating element (e.g., that is configured to absorb other light and thereby provide heat), or another type of element to provide heat to at least a portion of one or more optical transmission components of a photonic element 404. By providing heat, the modulation element may adjust optical properties, such as refractive indexes, of the one or more optical transmission components of the photonic element 404, which can shift of a phase of light propagating via the one or more optical transmission components of the photonic element 404.

As indicated above, FIG. 8 are provided as an example. Other examples may differ from what is described with regard to FIG. 8. In practice, the network 802 may include additional photonic elements 804; fewer photonic elements 804; different photonic elements 804; or differently arranged photonic elements 804 than those shown in FIG. 8.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A photonic element, comprising:
a substrate;
a plurality of layers disposed in a stack configuration in a first direction on the substrate; and
a first optical transmission component, a second optical transmission component, a third optical transmission component, and a fourth optical transmission component, wherein:
the first optical transmission component includes one or more optical transmission structures that are disposed in a first layer of the plurality of layers,
the second optical transmission component includes one optical transmission structure that is disposed in a second layer of the plurality of layers,
the third optical transmission component includes one optical transmission structure that is disposed in a third layer of the plurality of layers,
the fourth optical transmission component includes one or more optical transmission structures that are disposed in a fourth layer of the plurality of layers, and
the second layer and the third layer are each disposed between the first layer and the fourth layer in the stack configuration.

2. The photonic element of claim 1, wherein the one optical transmission structure of the second optical transmission component and the one optical transmission structure of the third optical transmission component are arranged in an aligned vertical configuration.

3. The photonic element of claim 1, wherein the one optical transmission structure of the second optical transmission component and the one optical transmission structure of the third optical transmission component are arranged in a non-aligned vertical configuration.

4. The photonic element of claim 1, wherein:
the one or more optical transmission structures of the first optical transmission component and the one or more optical transmission structures of the fourth optical transmission component are associated with a first quadrilateral region of the photonic element in the first direction that includes at least portions of the first layer, the second layer, the third layer, and the fourth layer;
the one optical transmission structure of the second optical transmission component and the one optical transmission structure of the third optical transmission component are associated with a second quadrilateral region of the photonic element in the first direction that includes at least portions of the second layer and the third layer; and
the first quadrilateral region surrounds the second quadrilateral region.

5. The photonic element of claim 1, wherein each optical transmission component of the first optical transmission component, the second optical transmission component, the third optical transmission component, and the fourth optical transmission component is at least one of:
a waveguide;
an interferometer;
an optical switch; or
an optical resonator.

6. The photonic element of claim 1, wherein:
at least a portion of the second optical transmission component and at least a portion of the third optical transmission component are associated with a central region of the photonic element in a second direction that is orthogonal to the first direction; and
no portion of the first optical transmission component and no portion of the fourth optical transmission component are associated with the central region of the photonic element in the second direction.

7. The photonic element of claim 1, wherein at least one of the first optical transmission component, the second optical transmission component, the third optical transmission component, or the fourth optical transmission component comprises at least one of:
a non-alkali, oxide solution that includes a cation that is niobium;
an alkali oxide material;
an amorphous silicon (a-Si) material;
a hydrogenated amorphous silicon (a-Si:H) material;
a nitride-based material;
an oxide-based material; or
a semiconductor material.

8. The photonic element of claim 1, wherein at least one of:
the one optical transmission structure of the second optical transmission component and the one optical transmission structure of the third optical transmission component are configured to be evanescently coupled with each other;
the one optical transmission structure of the second optical transmission component and the one or more optical transmission structures of the first optical transmission component are configured to be evanescently coupled with each other; and
the one optical transmission structure of the third optical transmission component and the one or more optical transmission structures of the fourth optical transmission component are configured to be evanescently coupled with each other.

9. A photonic element, comprising:
a substrate;
a plurality of layers disposed in a stack configuration in a first direction on the substrate; and
a first optical transmission component, a second optical transmission component, a third optical transmission component, and a fourth optical transmission component, wherein:
the first optical transmission component includes two optical transmission structures that are disposed in a first layer of the plurality of layers,
the second optical transmission component includes two optical transmission structures that are disposed in a second layer of the plurality of layers,
the third optical transmission component includes one optical transmission structure that is disposed in a third layer of the plurality of layers,
the fourth optical transmission component includes two optical transmission structures that are disposed in a fourth layer of the plurality of layers, and
the second layer and the third layer are each disposed between the first layer and the fourth layer in the stack configuration, and
the two optical transmission structures of the second optical transmission component and the one optical transmission structure of the third optical transmission component are arranged in an offset triter configuration.

10. The photonic element of claim 9, wherein:
the two optical transmission structures of the first optical transmission component and the two optical transmission structures of the fourth optical transmission component are associated with a quadrilateral region of the photonic element in the first direction that includes at least portions of the first layer, the second layer, the third layer, and the fourth layer;
the two optical transmission structures of the second optical transmission component and the one optical transmission structure of the third optical transmission component are associated with a triangle region of the photonic element in the first direction that includes at least portions of the second layer and the third layer; and
the quadrilateral region surrounds the triangle region.

11. The photonic element of claim 9, wherein each optical transmission component of the first optical transmission component, the second optical transmission component, the third optical transmission component, and the fourth optical transmission component is at least one of:
a waveguide;
an interferometer;
an optical switch; or
an optical resonator.

12. The photonic element of claim 9, wherein:
at least a portion of the second optical transmission component and at least a portion of the third optical transmission component are associated with a central region of the photonic element in a second direction that is orthogonal to the first direction; and
no portion of the first optical transmission component and no portion of the fourth optical transmission component are associated with the central region of the photonic element in the second direction.

13. The photonic element of claim 9, wherein at least one of the first optical transmission component, the second optical transmission component, the third optical transmission component, or the fourth optical transmission component comprises at least one of:
a non-alkali, oxide solution that includes a cation that is niobium;
an alkali oxide material;
an amorphous silicon (a-Si) material;
a hydrogenated amorphous silicon (a-Si:H) material;
a nitride-based material;
an oxide-based material; or
a semiconductor material.

14. The photonic element of claim 9, wherein at least one of:
at least one of the two optical transmission structures of the second optical transmission component and the one optical transmission structure of the third optical transmission component are configured to be evanescently coupled with each other;
at least one of the two optical transmission structures of the second optical transmission component and the two optical transmission of the first optical transmission component are configured to be evanescently coupled with each other; and
the one optical transmission structure of the third optical transmission component and the two optical transmission of the fourth optical transmission component are configured to be evanescently coupled with each other.

15. A network of photonic elements, comprising:
a substrate; and
a plurality of photonic elements disposed on respective regions of the substrate, wherein
each photonic element, of the plurality of photonic elements, includes a first optical transmission component, a second optical transmission component, a third optical transmission component, and a fourth optical transmission component in a stack configuration, wherein:
the first optical transmission component includes one or more optical transmission structures,
the second optical transmission component includes one or two optical transmission structures,
the third optical transmission component includes one optical transmission structure,
the fourth optical transmission component includes one or more optical transmission structures, and
the second optical transmission component and the third optical transmission component are each disposed between the first optical transmission component and the fourth optical transmission component in the stack configuration.

16. The network of photonic elements of claim 15, wherein:
a first photonic element, of the plurality of photonic elements, is associated with a first optical transmission component configuration that is one of a triter configuration, an offset triter configuration, an aligned vertical configuration, or a non-aligned vertical configuration.

17. The network of photonic elements of claim 16, wherein:
a second photonic element, of the plurality of photonic elements, is associated with a second optical transmission component configuration that is one of a triter configuration, an offset triter configuration, an aligned vertical configuration, or a non-aligned vertical configuration and that is different than the first optical transmission component configuration.

18. The network of photonic elements of claim 15, wherein a first optical transmission component of a first photonic element, of the plurality of photonic elements, is connected to a first optical transmission component of a second photonic element of the plurality of photonic elements.

19. The network of photonic elements of claim 15, wherein at least one optical transmission component of the first optical transmission component, the second optical transmission component, the third optical transmission component, and the fourth optical transmission component of a photonic element, of the plurality of photonic elements, comprises at least one of:
a non-alkali, oxide solution that includes a cation that is niobium;
an alkali oxide material;
an amorphous silicon (a-Si) material;
a hydrogenated amorphous silicon (a-Si:H) material;
a nitride-based material;
an oxide-based material; or
a semiconductor material.

20. The network of photonic elements of claim 15, wherein the first optical transmission component, the second optical transmission component, the third optical transmission component, and the fourth optical transmission component of a photonic element, of the plurality of photonic elements, are respectively disposed in a plurality of layers that are disposed on the substrate.
